(19) United States
(12) Patent Application Publication
(10) Pub. No.: US 2015/0206446 A1
(43) Pub. Date: Jul. 23, 2015

(54) AUTHORING, SHARING, AND CONSUMPTION OF ONLINE COURSES

(71) Applicant: Microsoft Technology Licensing, LLC., Redmond, WA (US)

(72) Inventors: Anoop Gupta, Woodinville, WA (US); Aravind Bala, Redmond, WA (US); Subha Bhattacharyay, Medina, WA (US); Jeannette A. Gatlin, Seattle, WA (US); Guillaume Simonnet, Bellevue, WA (US); Anand Prakash, Bothell, WA (US); Kurt William Berglund, Seattle, WA (US); Kirshnamurthy Ganesan, Redmond, WA (US); Aaron D. Coldiron, Bellevue, WA (US); Nick Reid Barling, Redmond, WA (US)

(21) Appl. No.: 14/602,010

(22) Filed: Jan. 21, 2015

Related U.S. Application Data
(60) Provisional application No. 61/930,284, filed on Jan. 22, 2014.

(51) Int. Cl. G09B 5/08; G06F 17/24; G06F 17/21

(52) U.S. Cl. CPC G09B 5/08; G06F 17/211; G06F 17/242

(57) ABSTRACT

Technologies are described herein for authoring, sharing, and consuming online courses. A lesson creation extension executing in conjunction with a presentation application can be utilized to create an augmented presentation document having one or more slides. A video recording of a presentation of the slides may be made and associated with the slides. Digital ink made on the slides may also be recorded. The slides might also be created to include quizzes, interactive labs, and other types of interactive content. The augmented presentation document can then be published to a portal system for sharing. A lesson player can be utilized to play back the lesson from the portal system. During playback, the recorded audio, video and digital ink are played back in synchronization by the lesson player.

### CROSS-REFERENCE TO RELATED APPLICATION(S)

This application claims the benefit of U.S. Provisional Patent Application Ser. No. 61/930,284 filed on Jan. 22, 2014, entitled “AUTHORING, SHARING AND CONSUMPTION OF ONLINE COURSES,” the entirety of which is expressly incorporated herein by reference.

### BACKGROUND

In recent years there has been a disruptive trend toward providing educational courses online. In general, the online courses offered today are provided in video recorded lecture format. In this format, a video recording is made of the lecturer, e.g., standing at a podium or on a stage, or at a chalkboard or whiteboard or on a virtual whiteboard displayed in the video. A student user views the video online, and may be presented with a multiple choice quiz or other type of test to assess their comprehension and mastery of the subject matter. Additional supplemental materials such as a slide deck, text document, hyperlinks to web pages, etc., may also be provided as separate download files.

While offering certain benefits, the present state of online course technologies lacks authoring flexibility for educators, as they generally require use of video editing tools to make any edits, modifications, deletions or additions to a recorded lecture. It is often difficult or even infeasible to insert quizzes, interactive exercises, web-content or linked-videos into the video-flow of lessons. There is also no easy way to obtain comprehensive analytics and statistics from student viewing of such lessons with linked interactive components.

It is with respect to these considerations and others that the disclosure made herein is presented.

### SUMMARY

Technologies are described herein for authoring, sharing and consumption of interactive online courses (which might also be referred to herein as “lessons”). In particular, an augmented presentation document format is provided for authoring, sharing and consumption of online courses that utilize slides with various objects including video objects and digital ink objects. In one example, the augmented presentation document is authored using a presentation application with a lesson creation extension that provides the additional online course authoring functionality and features described herein. Other content creation applications might also utilize and leverage the concepts presented herein, such as word processing applications, spreadsheet applications, electronic book applications, and others.

In the authoring process, a user, such as an educator, may prepare an augmented presentation document including a sequence of slides with content, such as chart objects, graph objects, photo objects, text objects, animation objects, embedded video objects/audio objects, hyperlink objects, etc. Utilizing various technologies disclosed herein, interactive content, such as quizzes, interactive laboratories (“labs”), and/or other types of content might also be inserted into the augmented presentation document as objects during the authoring process. Quiz objects may assess a student's progress in understanding the lessons. Quiz objects may include true/false questions, multiple choice questions, multiple response questions and/or freeform questions, for example. Interactive lab objects may enhance a student's mastery of the lessons through the utilization of various exercises. The user may create quiz objects and/or interactive lab objects or may be insert previously created objects. The user may also insert quiz objects and/or interactive lab objects from third parties such as KHAN ACADEMY.

The educator author then records a lecture of their presentation of the slides in the augmented presentation document. The lesson creation extension captures audio and video of the educator presenting the slides, and may also capture their writing on the slides in one or more digital ink objects. The lesson creation extension segments the recorded content into objects associated with individual slides of the augmented presentation document. In one example, each video object is the video captured of the educator while discussing the associated slide. The extension also captures the time sequence of the digital ink object, also associated with individual slides.

After recording the presentation, the author can edit the presentation by moving or deleting slides, which also moves or deletes that slide's video object in the overall slide-sequence of the presentation. This allows the author to easily modify the sequence of objects, and delete objects. Additionally, the author can add further slides, record video objects and/or digital ink objects associated with the slides, and then edit the additional slides into the original presentation.

Once the author has completed the creation of the augmented presentation document, the augmented presentation document may be uploaded to a portal system for sharing with other users, such as students. The portal system may provide functionality for searching, rating, and viewing of uploaded lessons. The portal system might also provide functionality for allowing an authorized user, such as an educator, to view statistics regarding the viewing of presentations, individual slides, and/or information regarding the use of quiz objects and interactive lab objects contained within presentations. The portal system might also provide forums and other types of community features for students, educators, and other users to share information regarding the lessons.

The portal system also provides functionality for playback of lessons on virtually any type of client computing device. In this regard, playback might be performed through the same application utilized to create a presentation (e.g. a presentation creation application), through the use of a playback tool implemented as a web browser plugin or in another manner, through a dedicated playback application, or in another manner.

During playback (e.g., for viewing by a student user), the augmented presentation document presents each slide synchronized with any objects, such as the slide's video object. The presentation may also present any digital ink object for that slide in a manner that is synchronized with the video object. The playback tool may display a progress bar with segmentation marks corresponding to a slide sequence. The viewer can select a specific point on the progress bar to commence playback, which will go to the associated slide in the augmented presentation document and start playback of the video object for the slide at the time corresponding to the selected point on the progress bar.

According to one aspect presented herein, a system for publishing is provided for an augmented presentation document. The system includes a processor and a memory coupled to the processor storing computer-executable instructions. The computer-executable instructions execute in the processor from the memory. The system receives the augmented presentation document, which comprises one or more slides. As described above, the slides have one or more objects associated therewith. In one implementation, the system extracts objects from the augmented presentation document and stores the objects by object type. Additionally, the system may retrieve the stored objects in response to receiving a request to present the augmented presentation document. The system may also cause the augmented presentation document to be presented in synchronization with the objects.

According to another aspect, a computer-implemented method is provided for creating an augmented presentation document. In one implementation, the method includes executing a lesson creation extension in a presentation application to create the augmented presentation document comprising one or more slides. The method may further include recording one or more types of content. The method may also segment the content into objects, with each object associated with a slide so that the objects and the slides may be presented in synchronization during playback.

According to yet another aspect, a computer-implemented method is provided for receiving an augmented presentation document with one or more slides. The slides of the augmented presentation document having one or more associated objects. In one implementation, the method includes extracting the objects from the augmented presentation document and storing the objects by object type. The method may also include retrieving the object in response to receiving a request to present the augmented presentation document. The method may also provide causing the augmented presentation document to be presented in synchronization with the objects.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram showing aspects of an illustrative system disclosed herein for authoring, sharing, and consuming online lessons;

FIG. 2 is a flow diagram showing an illustrative routine that illustrates aspects of the operation of the system illustrated in FIG. 1;

FIGS. 3 and 4 are UI diagrams showing illustrative UIs generated by a presentation application and a lesson creation extension for authoring a lesson;

FIGS. 5 and 6 are UI diagrams showing illustrative UIs generated by a presentation application and a lesson creation extension for publishing a lesson to a portal system;

FIG. 7 is a system diagram showing aspects of an illustrative portal system disclosed herein that provides functionality for discovering lessons, providing an online community associated with lessons, playing back lessons, and providing analytics regarding the utilization of lessons;

FIG. 8 is a system diagram showing aspects of an illustrative portal system disclosed herein that provides storage for objects of an augmented presentation document;

FIG. 9 is a flow diagram showing an illustrative routine that illustrates aspects of the operation of the portal system illustrated in FIGS. 7 and 8;

FIG. 10 is a system diagram showing aspects of the operation of the portal system and a lesson player for consuming online lessons and for providing analytics to the portal system regarding the consumption of online lessons;

FIG. 11 is a flow diagram showing an illustrative routine that illustrates aspects of the operation of a lesson player in one configuration;

FIG. 12 is a UI diagram showing graphical UIs generated during the playback of an online lesson utilizing the portal system;

FIGS. 13-15 are UI diagrams showing graphical UIs generated by the portal system for viewing analytics regarding the consumption of lessons;

FIG. 16 is a computer architecture diagram illustrating an illustrative computer hardware and software architecture for a computing system capable of implementing aspects of the technologies presented herein;

FIG. 17 is a diagram illustrating a distributed computing environment capable of implementing aspects of the technologies presented herein; and

FIG. 18 is a computer architecture diagram illustrating a computing device architecture capable of implementing aspects of the technologies presented herein.

### DETAILED DESCRIPTION

The following detailed description is directed to technologies for authoring, sharing, consuming, and obtaining feedback analytics for online courses. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several figures, aspects of a computing system and methodology for authoring, sharing, and consuming online courses will be described.

As discussed briefly above, the mechanism described herein utilizes three components in some configurations: 1) an authoring component that extends a presentation application in order to make interactive online lessons easy to create; 2) a lesson player application for students that allows students to learn from such interactive lessons on any device and platform of their choice; and 3) a web portal that allows teachers to publish, share, and manage the lessons they create, and to get analytics for their lessons to determine how they may guide students further.

As discussed further below, the mechanism described herein reduces network bandwidth usage by separately storing objects by object type. The objects of an augmented presentation document can be updated from a central location. The updated objects can be retrieved and rendered during playback. Having objects of the augmented presentation document in a central location increases user efficiency and also reduces network bandwidth usage. Additionally, the augmented presentation document increases user efficiency by leveraging familiarity with existing applications, such as a presentation application to create an online lesson with rich objects including video objects and digital ink objects.

An augmented presentation document (which might also referred to herein as a “lesson”) created utilizing the technologies disclosed herein may be experienced in any web browser on any platform. In one configuration, the lesson appears like a slideshow on the web or a video, but it is much more. At a base level, the viewer is presented the augmented presentation document as a slideshow that has been augmented with teacher narration (e.g. audio-video objects and dynamic inking objects on the slide). The narration works seamlessly with animations and other rich element objects of the slideshow. The student may also experience interactive quizzes that the teacher has inserted as quiz objects into the augmented presentation document to help with mastery of content. The student may also find additional resources, such as video objects from KHAN ACADEMY, seamlessly interleaved with the teacher's lesson to enhance their learning. The student may also find other interactive lab objects, from KHAN ACADEMY or other providers, to enhance and test their knowledge. Students can keep trying new questions until they feel they have achieved mastery. To maximize their understanding and mastery of topics, the lesson player application makes it easy to replay, skip or speed-up any parts of the lesson. All student interactions with the lesson player may be recorded so that information may be collected and analytics may be provided to the teacher to help them personalize and guide student learning.

In order to author such an augmented presentation document, a teacher may start with a slide deck that they already have, or they could create a new slides for the online lesson leveraging the familiar capabilities of their presentation application. They would then download an add-in lesson creation extension for their presentation application that implements some of the functionality disclosed herein. Video objects may be generated using a webcam or other video capture device. Digital ink objects may be generated using a Tablet PC or a stylus digitizer or a mouse, among other options.

Within the lesson creation extension, the teacher has tools to create an augmented presentation document. In some configurations, the teacher may utilize a “record lesson” button to record narration and inking to slides. The audio and video objects are automatically split between slides. The teacher or other author does not have to lecture continuously and can chose to review and redo on a slide granularity.

When the teacher exits the record lesson mode, the audio and video objects and digital ink objects will be presented and clearly associated with the slides. The video objects may be repositioned and resized. The slides may also be reordered to change the video objects in the lesson. New slides can be added to further embellish the lesson. These change may be occur while initially making the lesson or later.

In the lesson creation extension, other buttons may allow the teacher to add screen-recording, quizzes, videos, interactive labs, and web pages. In one implementation, the teacher may add a quiz object by selecting the type of quiz along with the questions, hints, etc. before inserting the quiz object. The questions will then appear at that spot in the augmented presentation document. Similarly, the teacher may insert a KHAN ACADEMY video object in the augmented presentation document by clicking on an add-video button, searching for the desired video object and inserting the video object into the augmented presentation document. Interactive lab objects from KHAN ACADEMY, or another provider, may be added into the augmented presentation document by clicking the add-lab button, searching for and inserting the interactive lab object into the augmented presentation document. These interactive lab objects may be HTML5 JAVASCRIPT websites. Once the teacher is finished adding to the lesson, the augmented presentation document may be published by utilizing a “publish” button to upload the augmented presentation document to a portal system to share with students.

A web portal is also provided that allows a teacher to further manage and share the augmented presentation documents created, and to see the analytics collected that describe how students have been interacting with the augmented presentation documents. In the portal, the teacher can rename the lesson, add a description for the lesson, and perform other functionality. The teacher may share the augmented presentation document with their class or another group of users by simply obtaining a uniform resource locator (“URL” or “hyperlink”) for the lesson and sharing the URL with their class through email or a learning management system. The teacher may share the augmented presentation document with their class or may make the augmented presentation document public.

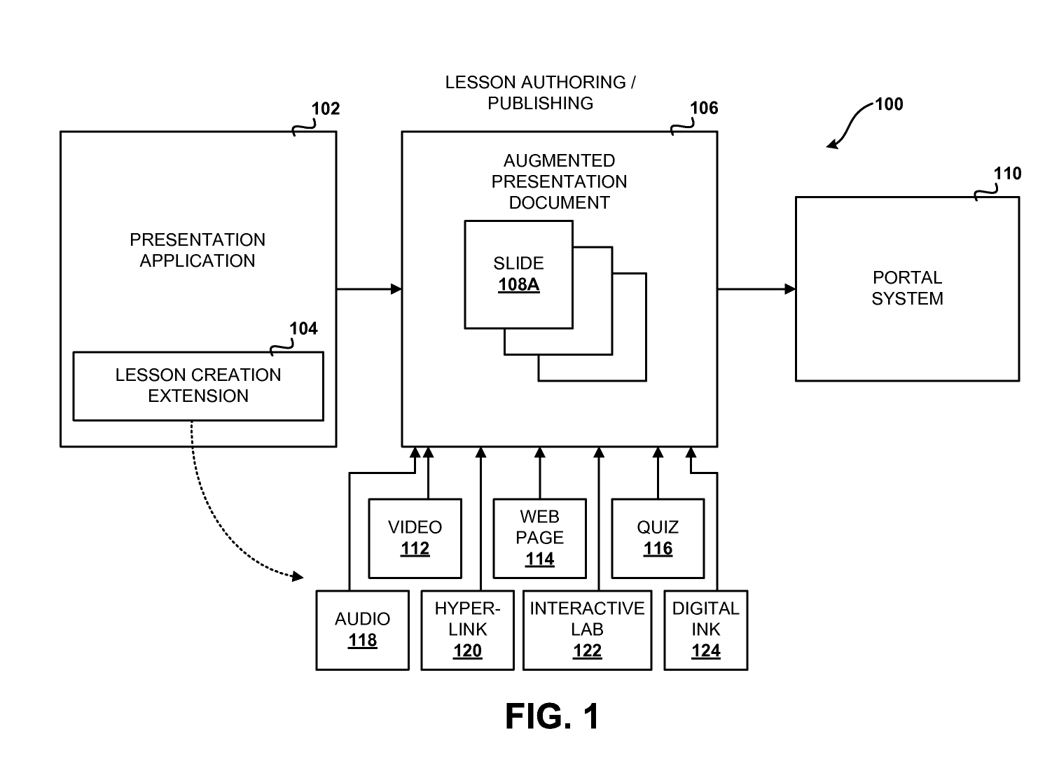

The portal may also allow the teacher to look at information collected for the lesson as analytics. For example, the teacher may see whether students have watched the assigned lesson, what portions they have watched, and how students have done on the quizzes and labs. This information may provide the teacher with essential information to further guide their students. Additional details regarding these mechanisms, and others, will be provided below with regard to FIGS. 1-18.

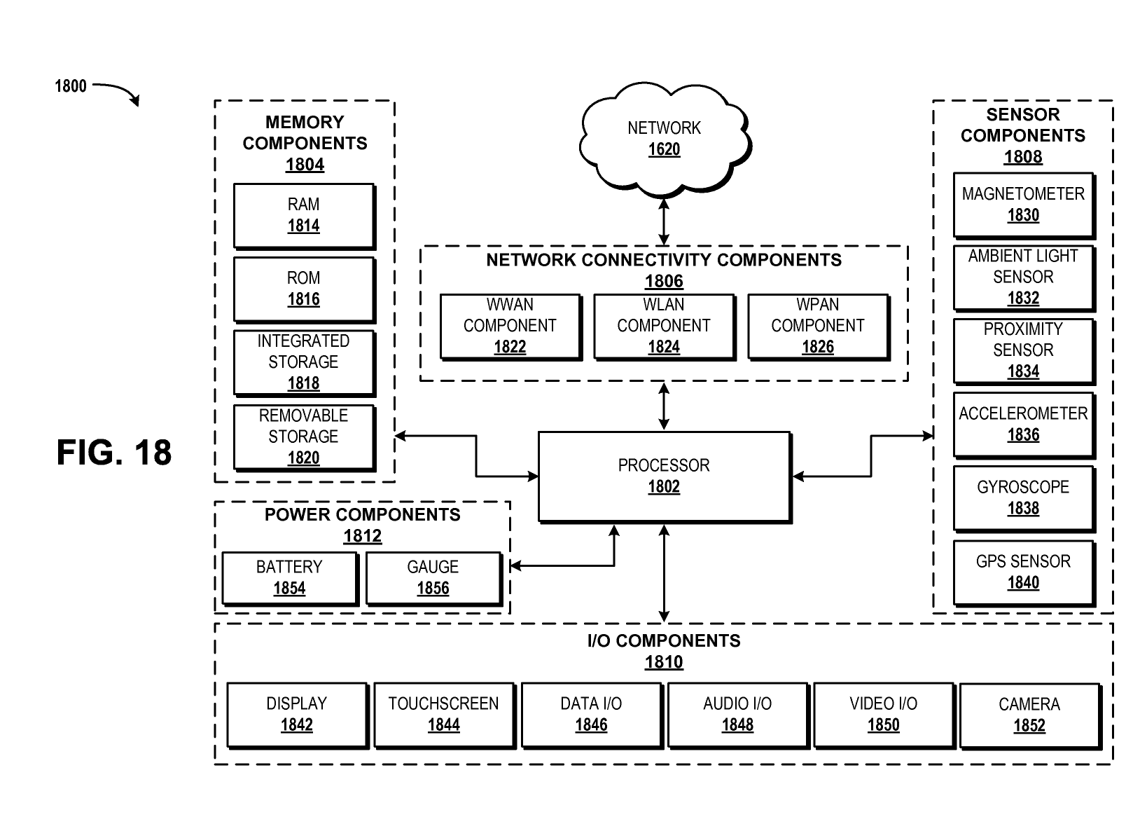

Turning now to FIG. 1, details will be provided regarding an illustrative operating environment and several software components disclosed herein. In particular, FIG. 1 is a system diagram showing aspects of an illustrative system disclosed herein for authoring, sharing, and consuming online lessons. The system 100 shown in FIG. 1 includes a computing device that is executing a presentation application 102. An example computing device architecture for implementing such a computing device is shown in FIG. 18 and is discussed below. In this regard, it should be appreciated that while the technologies disclosed herein are described in the context of a presentation application 102, the technologies described herein might also be utilized in a similar fashion with other types of content creation programs. For example, and without limitation, the technologies utilized herein might be implemented in conjunction with a word processing application, an electronic book creation application, a spreadsheet application, a note-taking application, and/or other types of applications.

As also shown in FIG. 1, a lesson creation extension 104 is provided in one configuration that executes in conjunction with the presentation application 102. The lesson creation extension 104 provides functionality for authoring and publishing a lesson in an online course format that utilizes an integrated slide, including objects such as digital ink object 124 and video object 112. The lesson is in a format of an augmented presentation document 106.

In the authoring process, a user of the presentation application 102, such as an instructor, prepares a slide presentation of a sequence of slides 108 with conventional slide presentation content, such as chart objects, graph objects, photos, text, embedded video objects 112, embedded audio objects 118, hyperlinks 120, web page objects 114, etc. The hyperlinks 120 may point to other slides in the same lesson. Interactive content, such as quiz objects 116, interactive “lab” objects 122, and other types of content might also be inserted into the slide presentation.

An author, such as an instructor, may record a video narration of their presentation of the slides 108. The lesson creation extension 104 captures a video of the instructor presenting the slides 108, and may also capture their writing on the slides 108 as a form of digital ink objects 124. The lesson creation extension 104 segments the recorded video into segments associated with individual slides 108 of the slide presentation, whereby each video object 112 is the video captured of the instructor while discussing an associated slide 108. The lesson creation extension 104 also captures the time sequence of the digital ink objects 124, which is associated with individual slides 108.

After recording, the user can edit the augmented presentation document 106 by moving or deleting slides 108, which also moves or deletes that slide's video object 112. This allows the user to easily modify the sequence of objects, and delete objects. Additionally, the user can add further slides, record video objects 112 and/or digital ink objects 124 associated with the slides 108, then edit the additional slides to thereby create the augmented presentation document 106.

Once the user has completed the creation of the augmented presentation document 106, the augmented presentation document 106 may be uploaded to a portal system 110 for sharing with other users. The portal system 110 may provide functionality for searching, rating, and viewing of uploaded lessons. The portal system 110 might also provide functionality for allowing an authorized user, such as an instructor, to view collected information as statistics regarding the viewing of augmented presentation documents 106, individual slides 108, and/or information regarding the use of quiz objects 116 and interactive lab objects 122 contained within the augmented presentation document 106. The portal system 110 might also provide forums and other types of community features for students, educators, and other users to share information regarding the lessons.

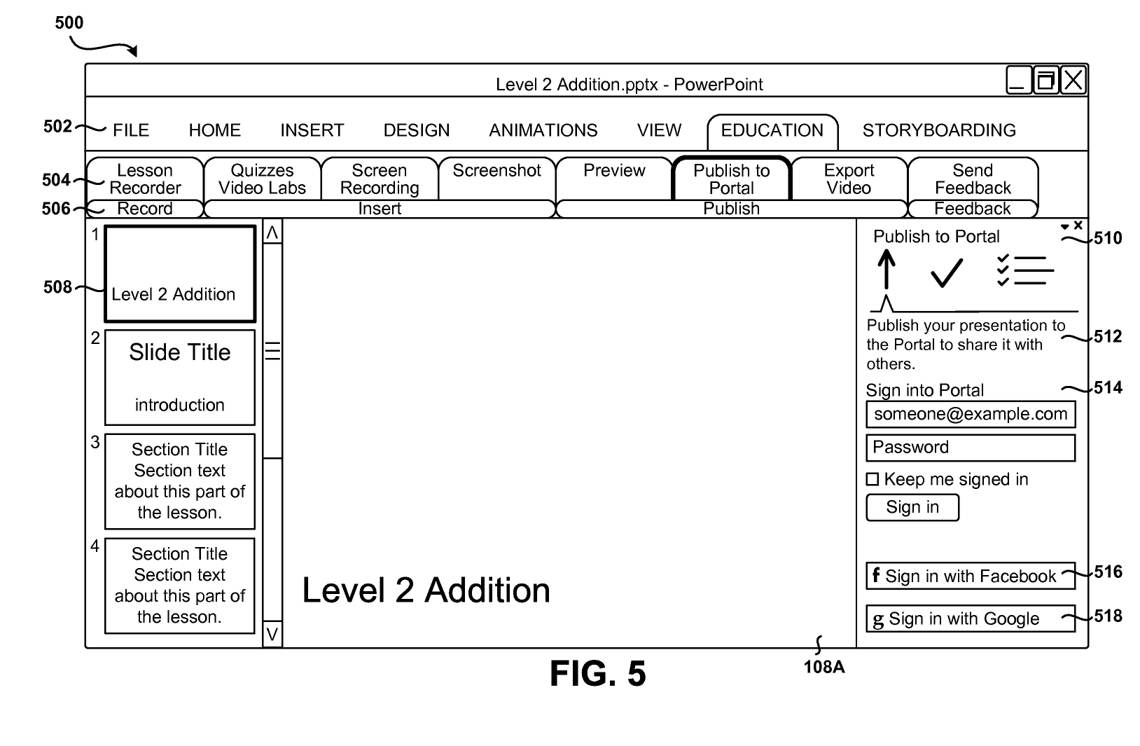

The portal system 110 may also provide functionality for playback of lessons on virtually any type of client device. In this regard, playback might be performed through the same application utilized to create an augmented presentation document 106, through the use of a playback tool implemented as a web browser plugin, through a dedicated playback application, or in another manner. During playback (e.g., for viewing by a student user), the augmented presentation document 106 presents each slide 108 in its sequence, along with the slide's video object 112. The augmented presentation document 106 may also present any digital ink object 124 for that slide 108 with timing coordinated to the video object 112 or the audio object 118, or if neither is desired the video object 112 can be substituted for a video containing only blank pictures. Additional details regarding the portal system 110 and playback of a lesson authored using the mechanisms described herein are provided below with regard to FIGS. 5-15.

As discussed briefly above, the lesson creation extension 104 is configured to record digital ink objects 124 in some configurations. In this way, an author can write and draw directly in the augmented presentation document 106, just as the author would on a whiteboard. Digital ink objects 124 are captured in time sequence and can be played back on the slide 108 in synchronization with the accompanying video objects 112 and/or audio objects 118. The computing device may utilize an appropriate digitizer, such as a touchscreen to enable capture of digital ink objects 124. Touchscreens are discussed further below with regard to FIG. 18.

It should be appreciated that when the augmented presentation document 106 is played back, the augmented presentation document 106 is not presented as a video. Rather, the augmented presentation document 106 is presented as a slide presentation with accompanying video objects 112. This may result in a presentation with a higher visual quality than when video alone is utilized that is scalable across different devices. This implementation might also save network bandwidth as opposed to a pure video lesson. Recorded digital ink objects 124 may also be rendered over the image of the slide presentation.

As discussed briefly above, lessons created using the lesson creation extension 104 might be made more engaging by adding: quiz objects 116; audio objects 118; digital ink objects 124; screen-capture objects; video objects 112; interactive lab objects 122; and/or exercises to the slides 108 in the augmented presentation document 106. Quiz objects 116 provide functionality allowing quizzing of the viewer of the augmented presentation document 106. For example, and without limitation, quiz objects 116 may include true/false questions, multiple choice questions, multiple response questions, short answer questions, and/or freeform questions.

Interactive “lab” objects 122 might also be utilized in lessons created using the lesson creation extension 104. Interactive lab objects 122 may be created using HTML5/JAVASCRIPT, and/or using other technologies. In some implementations, adding an interactive lab object 122 to an augmented presentation document 106 is similar to adding clipart. Interactive lab objects 122 can be reused and can also be configured to provide analytics regarding their use to an authorized user, such as a teacher, through the portal system 110. Other types of elements or objects may also be placed in the augmented presentation document 106 and presented during playback including, but not limited to, hyperlinks 120, web page objects 114, video objects 112, audio objects 118, graphics, and other element objects. Quiz objects 116 and/or interactive lab objects 122 are added by plug-in applications to the presentation application 102 in one configuration. Quiz objects 116 and interactive lab objects 122 may also be shared and may be used by the same or different users in other lessons.

As discussed briefly above, audio objects 118 and/or video objects 112 of a user presenting the slides 108 may be recorded. In various configurations, the video is split so that the portion of video corresponding to each slide 108 may be presented separately. In this way, a consumer can view recorded video on a per slide basis. Additionally, this allows slides 108 to be rearranged (e.g. reordered, added, deleted, etc.) and the accompanying audio objects 118 and/or video objects 112 will stay with its associated slide 108. Video objects 112 and/or audio objects 118 associated with each slide 108 can also be edited or deleted separately from the video objects 112 associated with other slides 108.

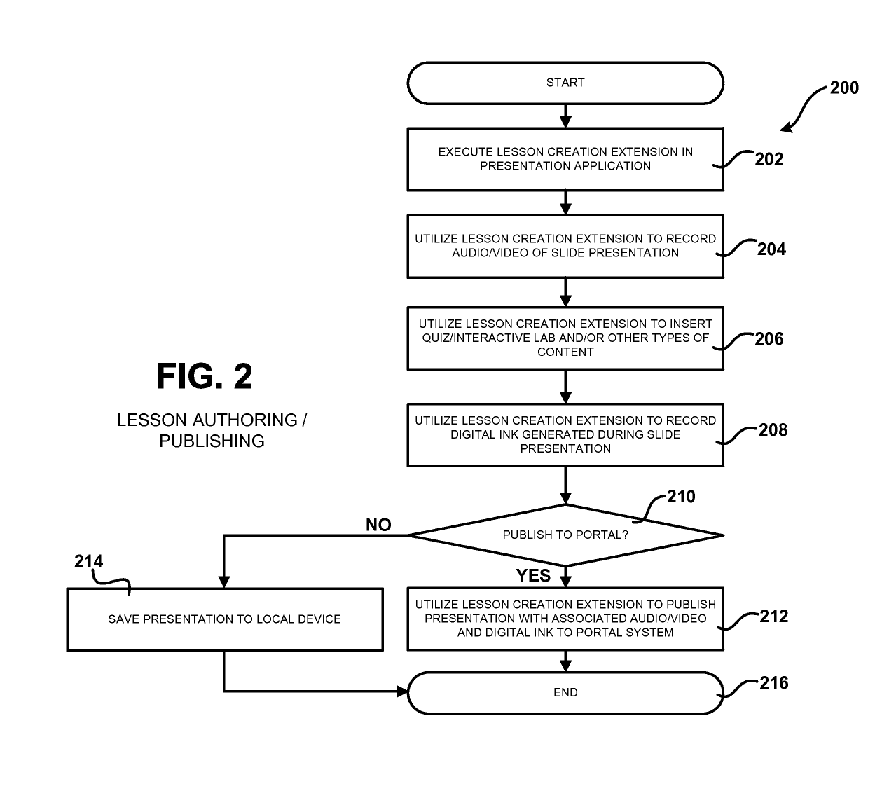

The augmented presentation document 106 can be saved to a local client device in the same manner as a traditional presentation document. The augmented presentation document 106 can also be published to the portal system 110 when completed for sharing with others. During the publishing process, the augmented presentation document 106 is uploaded to the portal system 110, video objects 112 may be reformatted for web delivery, multiple resolution versions might be created for use on different devices and/or other types of processing may be performed. After publishing, the portal system 110 may perform background processing to optimize the lesson for faster play back. For example, the augmented presentation document 106 may be pre-processed for player consumption by encoding video objects 112 at different resolutions to allow for play back on slower networks. As will be described in greater detail below, a playback application may be utilized to allow a user to playback the slides 108, accompanying audio objects 118 and/or video objects 112, to engage with any quiz objects 116 and/or interactive lab objects 122 in the augmented presentation document 106 and to perform other functionality. Additional details regarding the operation of the lesson creation extension and related functionality will be provided below with regard to FIGS. 2-6.

Referring now to FIG. 2, additional details will be provided regarding the technologies presented herein for authoring, publishing, and consuming online lessons. In particular, FIG. 2 is a flow diagram showing an illustrative routine 200 that illustrates aspects of the operation of the system illustrated in FIG. 1.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200 begins at operation 202, where the lesson creation extension 104 is downloaded, installed, and executed in the presentation application 102. The lesson creation extension 104 may be provided by the portal system 110 or another network-based computing system.

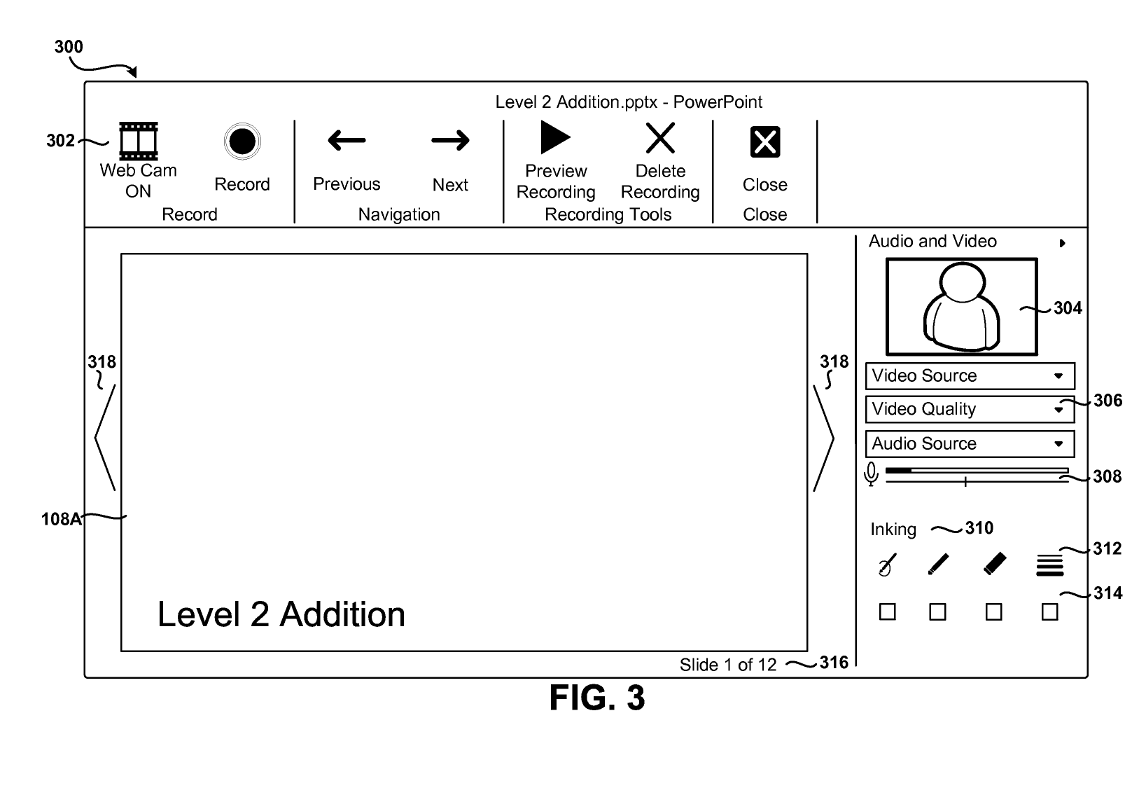

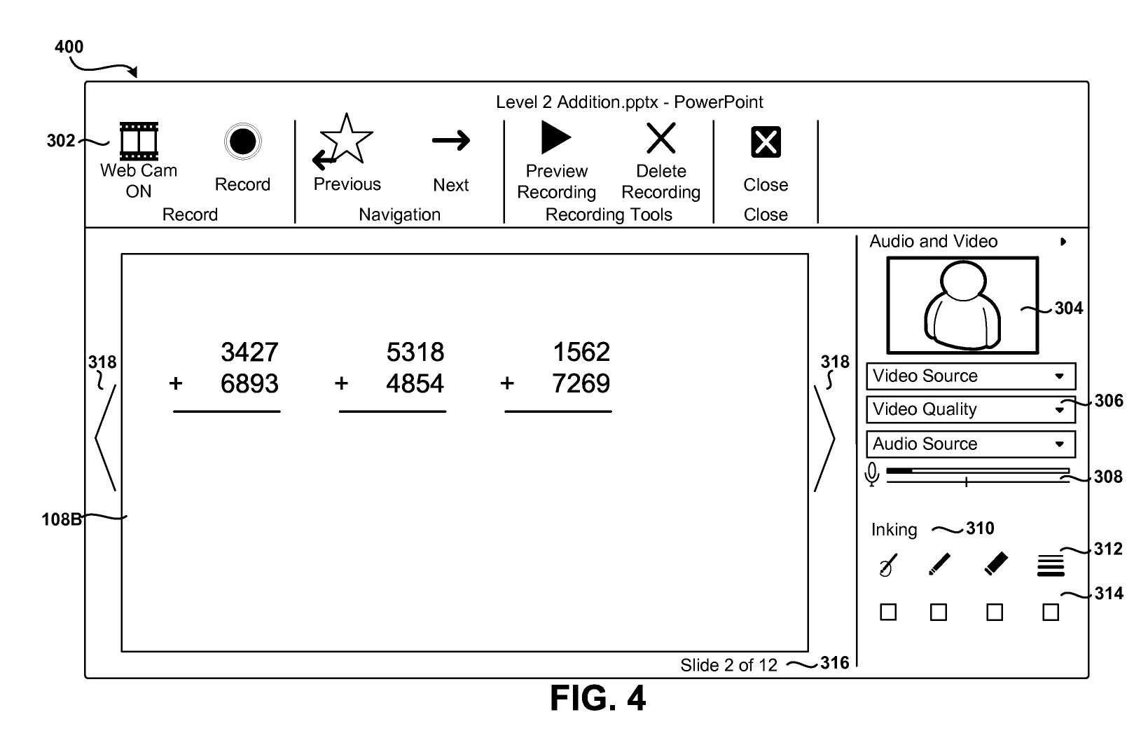

From operation 202, the routine 200 proceeds to operation 204, where a user may utilize the lesson creation extension 104 to create a slide presentation to record audio objects 118 and/or video objects 112 of an augmented presentation document 106 of the slides 108. From operation 204, the routine 200 proceeds to operation 206, where the lesson creation extension 104 may be utilized to insert quiz objects 116, interactive lab objects 122, and/or other types of content into the slides 108 in the augmented presentation document 106. At operation 208, the lesson creation extension 104 might also be utilized to record digital ink objects 124 during the presentation of the slides 108. FIGS. 3 and 4, which are discussed below, are UI diagrams showing illustrative UIs generated by a presentation application 102 and a lesson creation extension 104 for authoring a lesson in this manner.

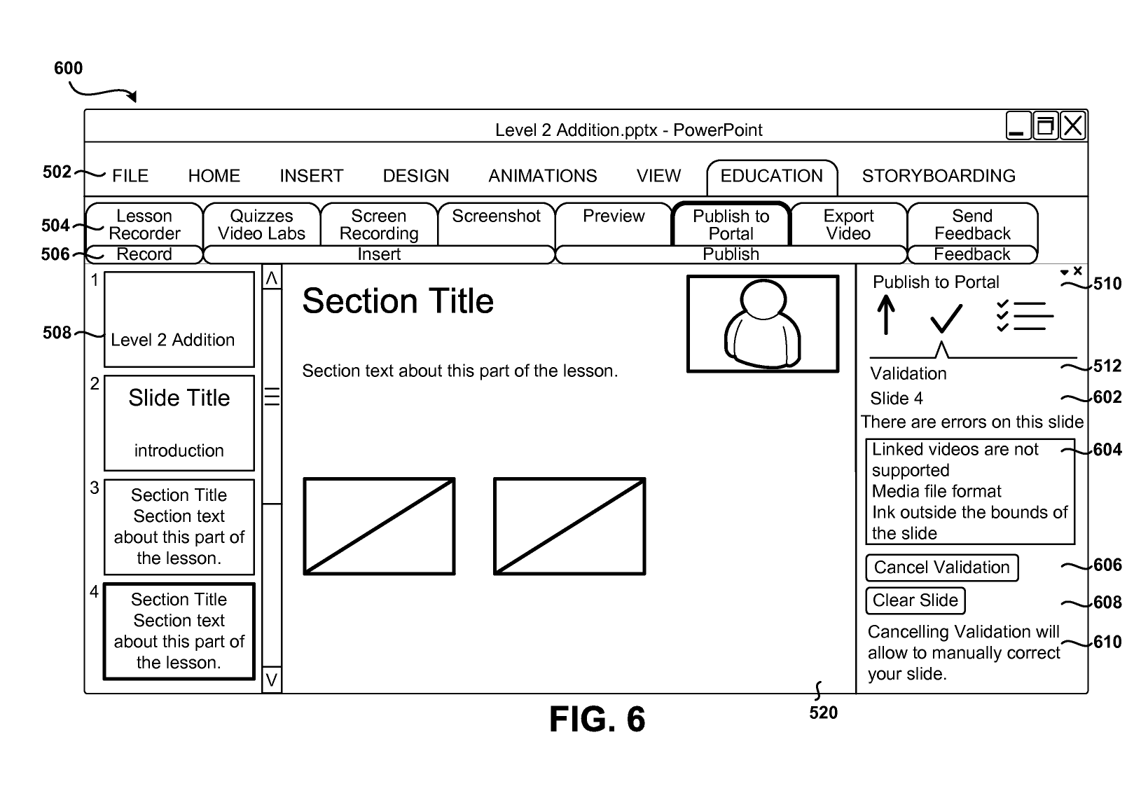

From operation 208, the routine 200 proceeds to operation 210, where the lesson creation extension 104 determines whether a user has requested to publish a lesson to the portal system 110. If a user requests to publish a lesson the routine 200 proceeds to operation 212, where the lesson creation extension 104 publishes the created augmented presentation document 106 to the portal system 110. As mentioned above, various types of operations such as reformatting of video objects 112 may be performed during the publishing process. FIGS. 5 and 6 are UI diagrams showing illustrative UIs generated by a presentation application 102 and a lesson creation extension 104 for publishing a lesson to a portal system 110. FIGS. 5 and 6 are discussed in more detail below. From operation 212, the routine 200 proceeds to operation 216, where it ends.

In response to determining in operation 210 that the lesson is not being published to the portal system 110, the routine continues 200 to operation 214. The augmented presentation document 106 may be saved to a local device at operation 214. Additionally, the augmented presentation document 106 may be played back from the local device. From operation 214, the routine 200 proceeds to operation 216, where the routine 200 ends.

Referring now to FIG. 3, UI diagram 300 will be described that shows an illustrative UI 300 generated by a presentation application 102 and a lesson creation extension 104 for authoring a lesson. In particular, the UI 300 shows an illustrative UI for recording a slide 108A of a lesson. The slide 108A of the augmented presentation document 106 is displayed in the UI diagram 300 along with a number of tools for authoring and inserting additional content into slide 108A.

Toolbar 302 contains a number of commands for authoring lesson content. The toolbar 302 shows that the web cam is currently on, via the “web Cam on” UI element. Video window 304 shows a video object 112 is currently being authored. The audio/video controls 306 allow for selecting the video and audio sources and for selecting the video quality of the video object 112 being authored. The volume control 308 allow a user to set a volume level for the recorded audio or video. Additionally, the volume controls 308 show an input audio level for audio currently being recorded.

In addition to authoring video objects 112 and audio objects 118, the UI 300 also has controls for authoring digital ink objects 124. In particular, the UI 300 contains an inking section 310 in one configuration. The inking section 310 contains UI controls for selection from a number of pen types 312. The pen types 312 provide different inputs for creating digital ink objects 124. The pen types 312 also allow for different weights to be selected for the inputs. The inking section 310 also allows for different colors 314 to be selected for the authored digital ink objects 124.

The UI 300 also enables different ways to navigate to different slides while authoring a lesson. In particular, a slide counter 316 displays the current slide shown in the UI 300. A user can navigate to a different slide by using the navigation commands in the toolbar 302. Additionally a user can navigate among the slides while authoring a lesson by using the navigation arrows 318 displayed on each side of the slide 108A.

Turning now to FIG. 4, another configuration of an illustrative UI 400 generated by a presentation application 102 and a lesson creation extension 104 for authoring an augmented presentation document 106 will be described. As shown in FIG. 4, a slide counter 316 indicates that the lesson being presented is on the second slide rather than the first slide. The slide 108B also has text relating to the lesson. The text could be inserted into slide 108B as conventional slide presentation content or could be generated using the inking section 310 to create a digital ink object 124. The lesson creation extension 104 captures the time sequence of the digital ink object 124 associated with slide 108B. The digital ink object 124 captured may be played back with accompanying video object 112 and/or audio object 118.

Referring now to FIGS. 5 and 6, several additional illustrative UIs 500 and 600 generated by a presentation application 102 and a lesson creation extension 104 for publishing an augmented presentation document 106 to a portal system 110 will be described. In particular, the UI 500 shown in FIG. 5 shows UI controls for logging into the portal system 110. These UI controls are in the “publish to portal” section 510. In the “publish to portal” section 510, progress indicator 512 shows steps involved in publishing the augmented presentation document 106 as icons. It should be understood that this configuration (and the other UI controls and configurations presented herein) is illustrative, and should not be construed as being limiting in any way.

The UI 500 also illustrates that a user needs to log into the portal system 110 to publish the augmented presentation document 106 to the portal system 110. A user may log into the portal system 110 by using controls in the portal log-in section 514. A user may also log into the portal system 110 by signing in using another already established account. For example, a user may sign into the portal system 110 using a FACEBOOK account with the FACEBOOK sign in button 516. Likewise, a user may sign into the portal system 110 using a GOOGLE account with the GOOGLE sign in button 518.

A user may navigate to the “publish to portal” section 510 by selecting “publish to portal” command in the “education toolbar” 504. The education toolbar 504 is split into different command categories 506 in one configuration. The “publish to portal” command is located in the “publish” category in the education toolbar 504. A user may navigate to the education toolbar 504 by selecting the EDUCATION tab from the main tabs list 502.

The UI 500 also illustrates a slide preview window 508, which allows a user to view and quickly navigate among the slides 108. The slide preview window 508 shows the first slide 108A as highlighted. Therefore, slide 108A is displayed in the UI diagram 500.

UI 600 shown in FIG. 6 illustrates a UI for validating the augmented presentation document 106 before publishing to the portal system 110 is complete. In particular, the progress indicator 512 shows that the augmented publishing document 106 is being validated. Status message 602 indicates whether there are validation errors. Error message 604 describes the type(s) of validation errors that exist. A user can cancel the validation process via the “cancel validation” button 606. Help text 610 lets a user know that using the cancel validation button 606 will allow the user to manually correct slide(s) by cancelling the current validation.

Alternately, a user could proceed with the validation by utilizing the “clear slide” button 608, which clears the slide and any errors on the slide. Once validation is completed, a message will be generated and the progress indicator 512 will also indicate completion of the publication process. It should be appreciated that the UIs presented herein are merely illustrative and that other configurations of UIs might be utilized in other implementations.

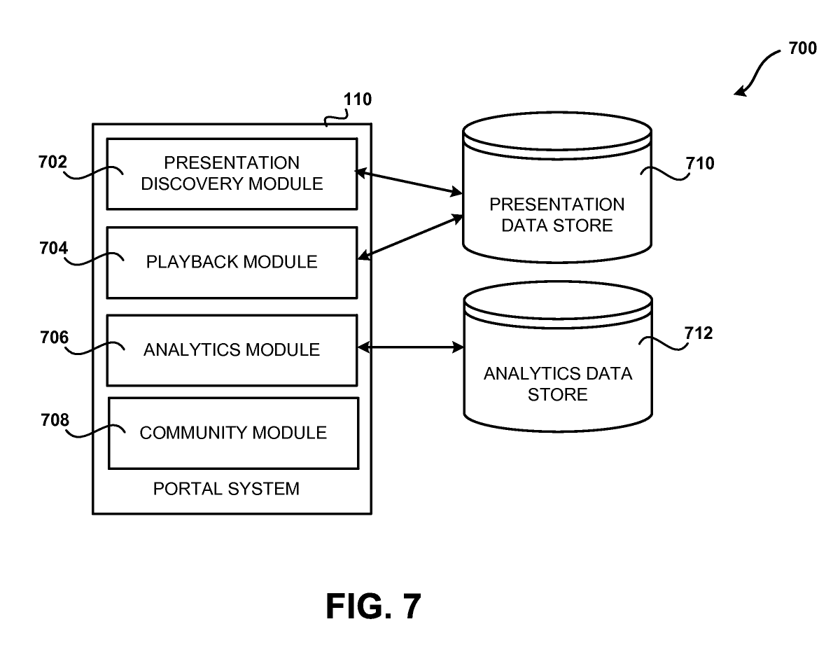

FIG. 7 is a system diagram showing a system 700 that illustrates aspects of a portal system 110 disclosed herein that provides functionality for discovering lessons, providing an online community associated with lessons, playing back lessons, and providing analytics regarding the utilization of lessons. As described briefly above, lessons may be published to the portal system 110 through the presentation application 102. Other interfaces might also be provided and utilized to publish lessons to the portal system 110. The portal system 110 may store the uploaded lessons in a suitable data store, illustrated in FIG. 7 as the presentation data store 710.

Additionally and as also described briefly above, the portal system 110 provides functionality in some configurations for sharing, discovery, rating, and viewing of lessons. In order to provide this functionality, the portal system 110 may include various computing systems that execute various software modules. In particular, the portal system 110 may execute a presentation discovery module 702 that provides functionality for allowing users to search for and otherwise discover available lessons. Through the use of this functionality, students can easily find lessons on topics of interest and, potentially, discover related content.

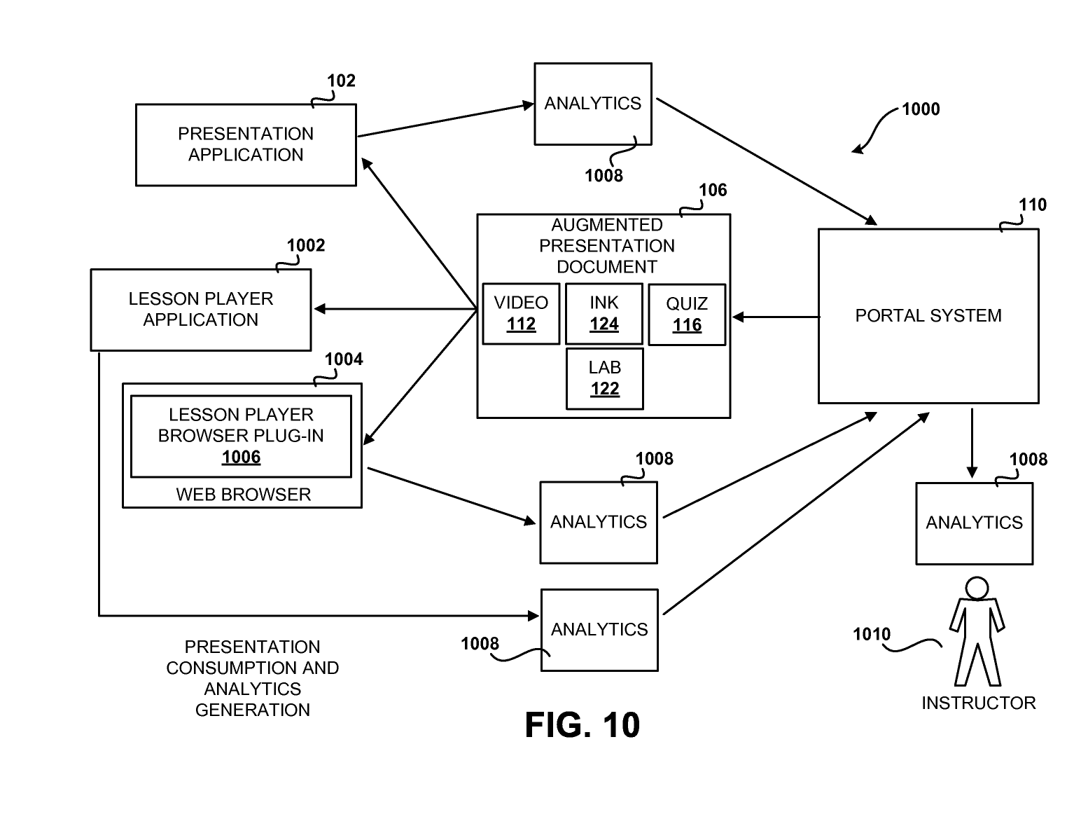

The portal system 110 might also execute a playback module 704 for streaming lessons to suitably configured client devices for playback. Additional details regarding the playback of lessons stored at the portal system 110 will be provided below with regard to FIGS. 10-12. In some configurations, the portal system 110 might also execute a community module 708 that provides functionality for providing a community, such as a social network or online forum, in which users can ask questions, share answers, and learn from a diverse community of students and teachers through an online forum.

The portal system 110 might also execute an analytics module 706. The analytics module 706 is configured to receive information collected from a playback program regarding the interaction with lessons and the content contained therein, such as quiz objects 116 and interactive lab objects 122. The collected information may be stored in an appropriate data store, such as the analytics data store 712. The collected information may be utilized for the benefit of both a teacher and a student. For example, the collected information may be used to personalize learning for particular students. The analytics module may be configured to receive collected information from objects, including interactive lab objects 122, regardless of the creator. Through this mechanism a teacher can be provided information regarding who viewed the content and how students did on any quiz objects 116 or interactive lab objects 122.

Analytics might include, but are not limited to, statistics showing the number of users that viewed particular slides, the time spent on each slide 108, the number of correct or incorrect answers given. These statistics might be provided on a per user or per lesson basis. Other types of analytics not specifically described herein might also be provided by the portal system 110.

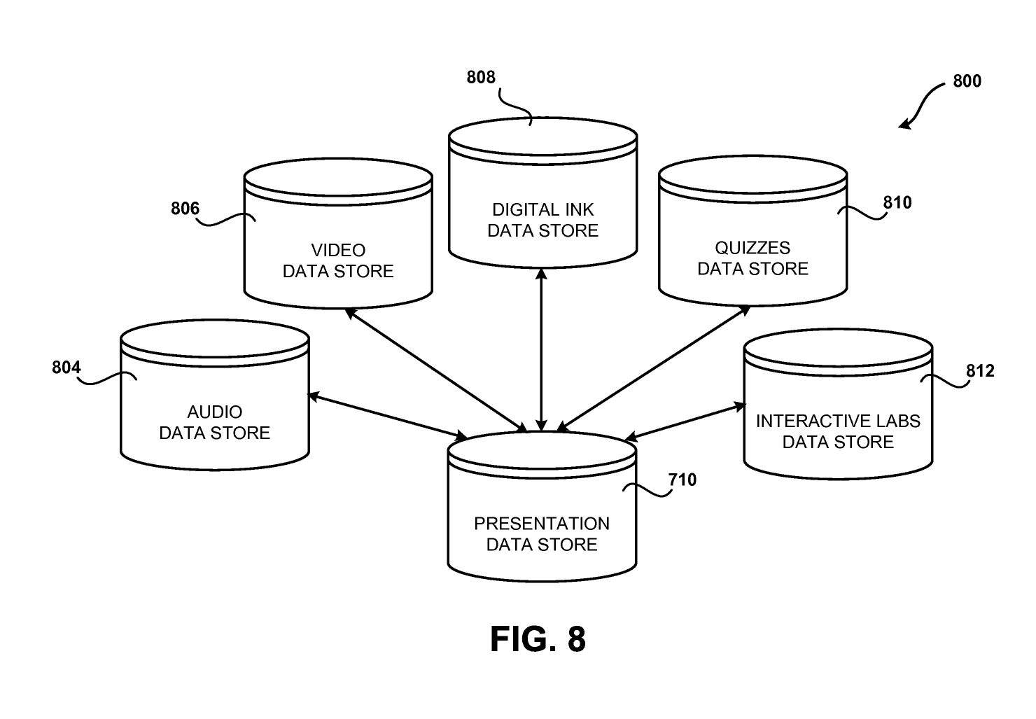

Turning now to FIG. 8, a system 800 will be described that illustrates additional aspects of a configuration of the presentation data store 710. In the configuration shown in FIG. 8, many of the elements or objects added to the augmented presentation document 106 may be stored separately from one another. For example, audio objects 118 that are added to an augmented presentation document 106 may be stored in an audio data store 804, while video objects 112 may be stored in a video data store 806. Other objects such as digital ink objects 124, quiz objects 116 and interactive lab objects 122 may be stored in a digital ink data store 808, quizzes data store 810 and an interactive labs data store 812, respectively.

As discussed above, objects such as quiz objects 116 might also be added to the augmented presentation document 106. These objects can be extracted or “shredded” from the augmented presentation document 106 and stored in another location. Quiz objects 116 for instance, may be stored in a quizzes data store 810. During playback of the augmented presentation document 106 the quiz objects 116, and/or other objects, will be retrieved and provided to the client application separately for rendering in a synchronized manner. It should also be appreciated that more or fewer data stores may be used than shown in the system diagram 800 and described herein.

The objects of an augmented presentation document 106 are extracted from the augmented presentation document 106 and stored separately. At playback, the objects may be retrieved and rendered. Storing the various objects separately from the augmented presentation document 106 allows the objects to be updated without having to have access to the entire augmented presentation document 106. Any updated objects can be retrieved and rendered into the augmented presentation document 106 during playback. An interactive lab object 122, for instance, may be updated while stored in the interactive labs data store 812. The updated interactive lab interactive 122 would be available when the augmented presentation document 106 is presented for playback.

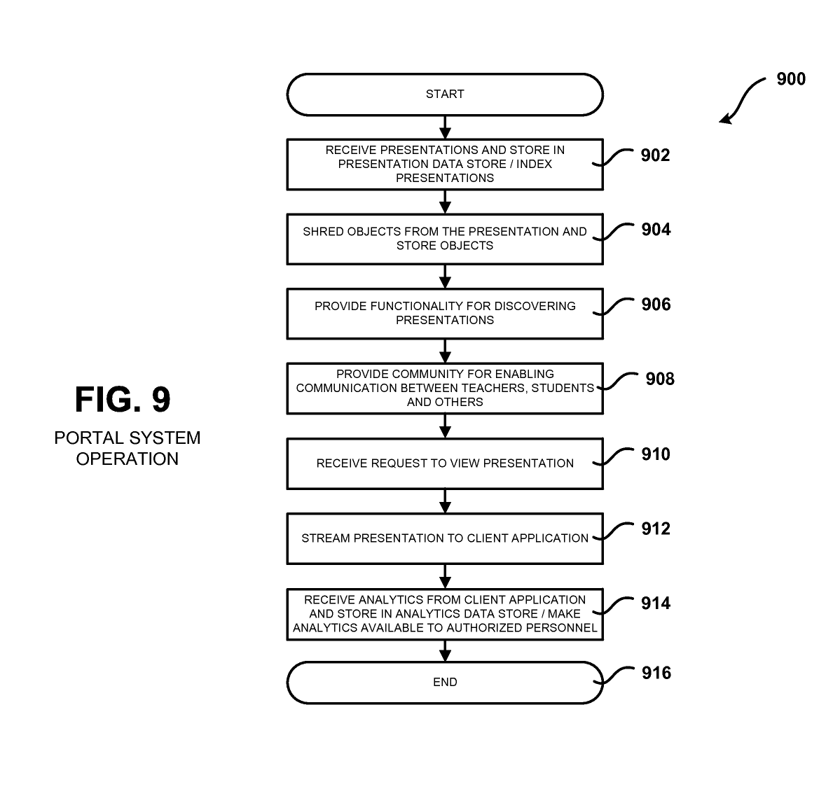

Referring now to FIG. 9, an illustrative routine 900 will be described that illustrates aspects of the operation of the portal system 110 illustrated in FIG. 7 and described above. The routine 900 begins at operation 902, where the portal system 110 receives lessons and stores them in the presentation data store 710. The augmented presentation document might also include metadata that can be indexed and utilized to search for lessons meeting certain criteria. The routine 900 next continues onto operation 904, where objects are extracted or shredded from the augmented presentation document 106. The objects removed from the augmented presentation document 106, can be stored separately from the augmented presentation document 106 as discussed above with regard to FIG. 8.

From operation 904, the routine 900 proceeds to operation 906, where the portal system 110 provides functionality for discovering lessons. For example, and as described briefly above, the presentation discovery module 702 may provide functionality for browsing lessons and/or searching for lessons meeting certain criteria. Other types of functionality for discovering lessons may also be provided.

From operation 906, the routine 900 proceeds to operation 908, where the portal system 110 might provide a community for discussing lessons and other topics. For example, and as discussed briefly above, the community module 708 might be executed to provide forums, social networks, or other types of communities for discussing lessons and other topics.

From operation 908 the routine 900 proceeds to operation 910, where the portal system 110 receives a request to view a lesson, for example at the playback module 704. In response to such a request, the routine 900 proceed to operation 912, where the playback module 704 streams the identified lesson to the lesson player (described below with regard to FIG. 10). The routine 900 then proceeds from operation 912 to operation 914, where the portal system 110 receives analytics describing the user's interaction with the lesson. The analytics module 706 receives the analytics and stores the analytics in the analytics data store 712. The collected information might then be made available to an authorized user, such as a teacher. From operation 914, the routine 900 proceeds to operation 916, where it ends.

FIG. 10 is a system diagram showing aspects of the operation of the portal system 110 and a lesson player application 1002 for consuming augmented presentation documents 106 and for providing analytics 1008 to the portal system 110 regarding the consumption of augmented presentation documents 106. As described above, a suitable client application can be utilized to view lessons stored at the portal system 110. In the example shown in FIG. 10, for instance, the presentation application 102, a dedicated lesson player application 1002, and a web browser 1004 configured with a lesson player browser plug-in 1006 are illustrated. Other applications might also be configured for use on various devices, such as smartphones, tablets, and other computing devices.

Utilizing one of these lesson player applications, students or other users can view, pause, rewind, or play lessons at variable speeds, helping students learn at their own pace. Playback of slides 108 and accompanying video objects 112 are synchronized and the recorded video objects 112 are displayed over the slides 108. Students view lessons on one device and pickup where they left off on another device. Students might also be permitted to take handwritten notes over the lesson.

Students can engage and interact with quiz objects 116 and/or interactive lab objects 122. When a quiz object 116 or an interactive lab object 122 is utilized, analytics 1008 are submitted to the portal. The analytics 1008 may be stored in the analytics data store 712. The analytics 1008 might also be made available to an authorized user, such as an instructor 1010. A student can stay on slides with quiz objects 116 or interactive lab objects 122 as long as needed and then move to the next slide when they are ready. The student can also view embedded content, like hyperlinks 120, video objects 112, digital ink objects 124, etc.

The player applications are multi-layered in some configurations. For example, a base layer might be configured to present the slides 108 of an augmented presentation document 106. On top of the base layer, a video layer may be configured to display the video object 112 associated with each slide. On top of that the video layer, an inking layer may be configured to display any associated digital ink object 124 that has been recorded in synchronization with the recorded audio object 118 and/or video object 112. A control layer might also be utilized that drives video, inking, seeking, move to next/previous slide, etc. In some implementations, the author can create an augmented presentation document 106 where some portions advance on user input and some portions that advance automatically.

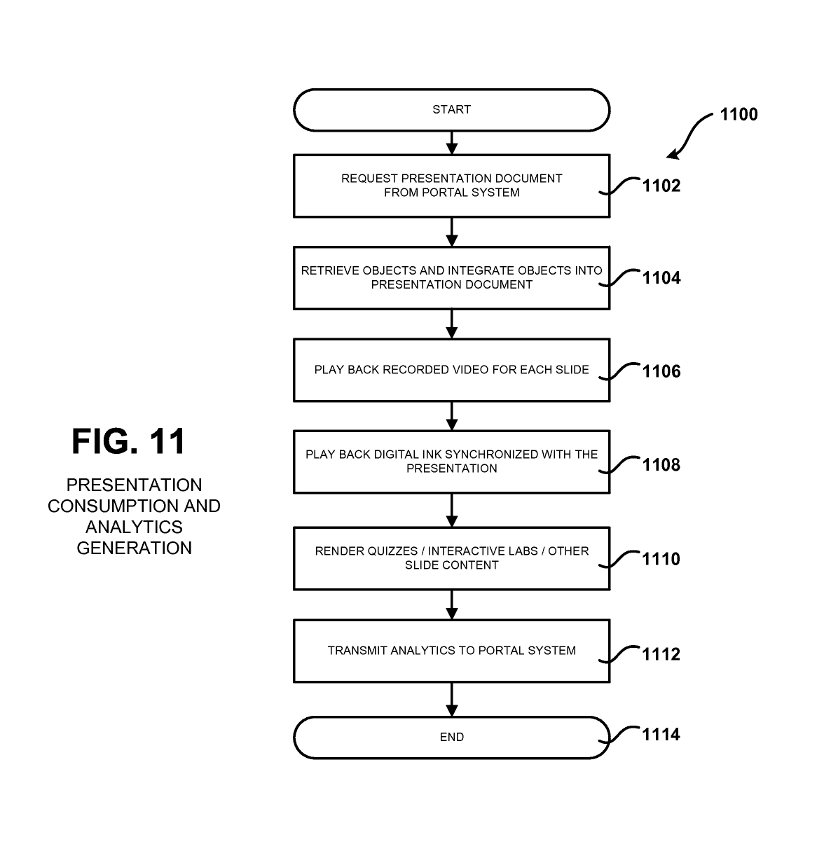

FIG. 11 is a flow diagram showing an illustrative routine 1100 that illustrates aspects of the operation of a lesson player in one configuration. The routine 1100 begins at operation 1102, where a lesson player can be utilized to request an augmented presentation document 106 from the portal system 110. From operation 1102, the routine 1100 continues to operation 1104. At operation 1104, objects are retrieved and integrated into the augmented presentation document 106. In some configurations, the objects are retrieved from the different storage locations using JAVASCRIPT.

The routine 1100 then proceeds to operation 1106 where the lesson player plays back the augmented presentation document 106, including video objects 112 recorded for each slide 108. The lesson player may replay the augmented presentation document 106 at variable speeds to help students learn at their own pace. Additionally, the lesson player may have a default playback speed at which the augmented presentation document 106 is played back. The default playback speed may be the same speed at which the lesson was recorded. In some configurations, the default playback speed may be faster or slower than the speed at which the lesson was recorded.

At operation 1108, the lesson player plays back digital ink objects 124 in synchronization with the recorded video objects 112. Synchronization allows the digital objects 124 to appear on the slides 108 at the same time as the video objects 112 appeared during the authoring process. At operation 1110, the lesson player renders any quiz objects 116, interactive lab objects 122, and/or other content contained in the presentation slides 108. The routine 1100 the proceeds to operation 1112 where it transmits analytics back to the portal system 110 for consumption by an authorized user, such as an instructor 1010. From operation 1112, the routine 1100 proceeds to operation 1114, where it ends.

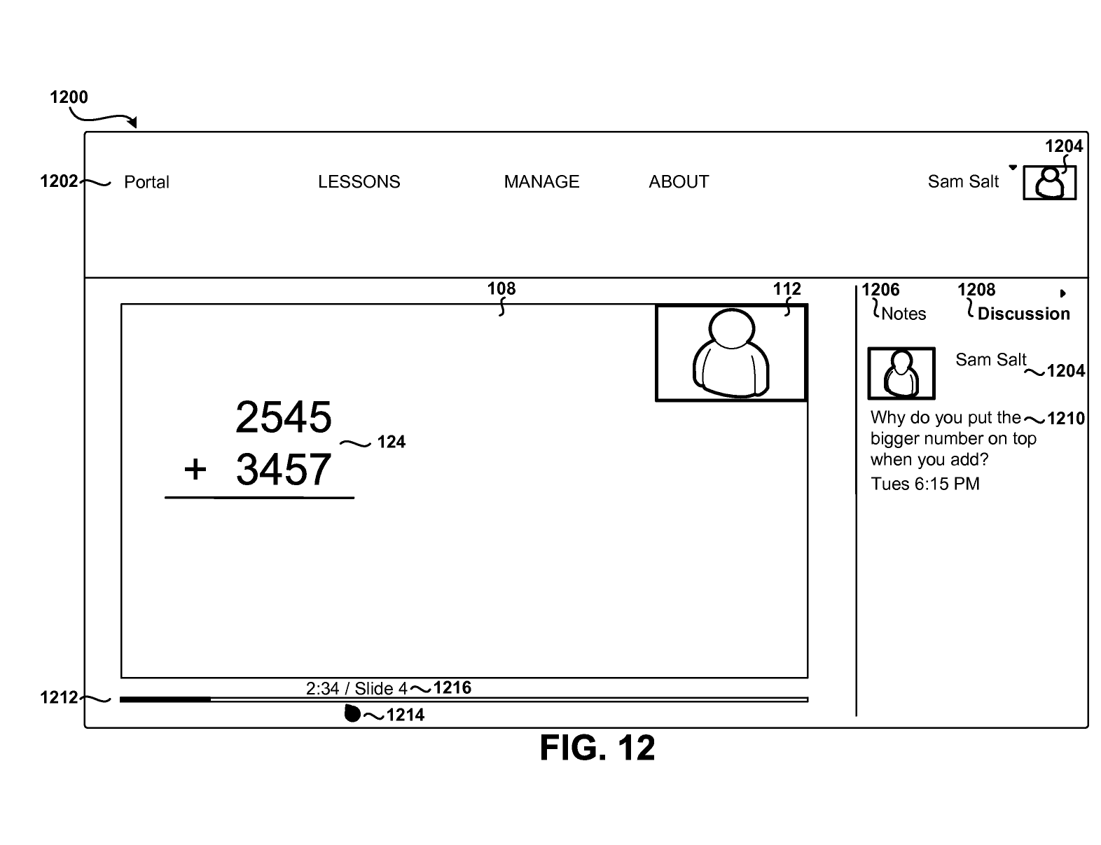

FIG. 12 shows a graphical UI 1200 generated during the playback of an augmented presentation document 106 utilizing the portal system 110. As discussed above, the augmented presentation document 106 may be played back using the presentation application 102, the web browser 1004, or a dedicated player such as lesson player application 1002. In one configuration, the UI 1200 contains a playback “ribbon” 1202. The playback ribbon 1202 groups commands for managing the playback of the lesson into categories shown in UI 1200. User profile 1204 lists the name of a user playing the augmented presentation document 106. The user profile 1204 also shows a profile picture associated with the user.

The UI 1200 also includes another section where the user can type notes or discuss the lesson. A notes tab 1206 and a discussion tab 1208 are also presented in this section of the UI diagram 1200. A user can toggle between these tabs by clicking on the headings. The discussion tab 1208 is selected in the UI 1200, as can be seen by the bold lettering. Other visual cues to indicate selection are also possible. Discussion text 1210 is a way for the user to interact with the instructor 1010 and/or other users when viewing the online lesson.

The UI diagram 1200 presents the slide 108 during playback, along with digital ink object 124 and video object 112 associated with the slide 108. The digital ink object 124 is played in synchronization with the video object 112. Both the digital ink object 124 and the video object 112 are synchronized with slide transitions of the slide 108. A progress bar 1212 shows the progress of the lesson playback in one configuration. Cursor 1214 can be used to jump to a different section of the playback by clicking on the progress bar 1212. Cursor text 1216 appears when the cursor 1214 hovers over the progress bar 1212. The cursor text 1216 indicates time and slide number relative to where the cursor 1214 is on the progress bar 1212.

The playback tool displays the progress bar 1212 with segmentation marks corresponding to the slide sequence. The viewer can select a specific point on the progress bar 1212 to commence playback, which will go to the associated slide 108 in the augmented presentation document 106 and start playback of the video object 112 for the slide 108 at the time corresponding to the selected point on the progress bar 1212.

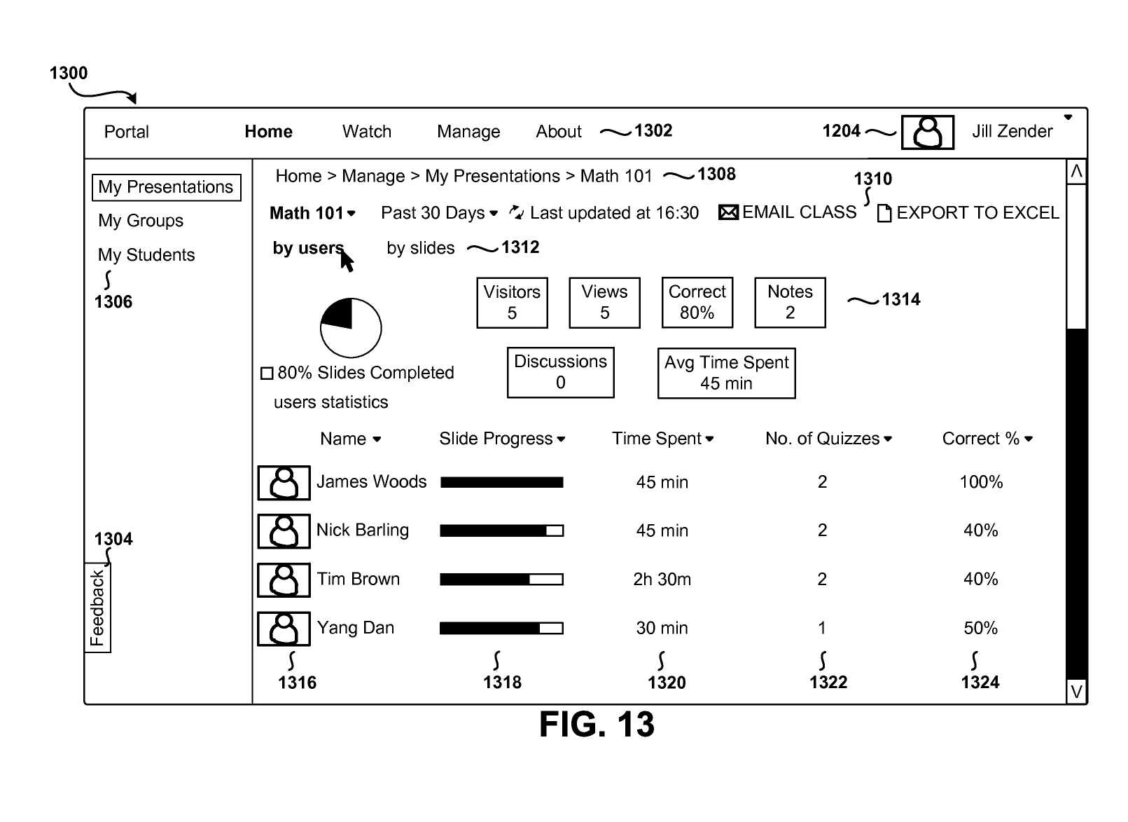

Turning now to FIGS. 13-15, UI diagrams showing graphical UIs generated by the portal system 110 for viewing analytics from information collected regarding the consumption of lessons will be described. In particular, the UI 1300 shown in FIG. 13 illustrates analytics about the consumption of lessons broken down by user. The UI 1300 contains analytics “ribbon” 1302. The analytics ribbon 1302 groups commands for managing the viewing of the analytics of lessons into categories shown in UI 1300. A feedback button 1304 exists to provide feedback regarding viewing analytics from the portal system 110. Analytics tabs 1306 allow a user to view analytics based upon presentations, groups or users.

UI 1300 presents analytics based upon the presentations of the user. Navigation menu 1308 provides another way for the user to navigate while viewing lesson analytics. Additionally, navigation menu 1308 visually shows the navigation path used to arrive at the screen presented in UI diagram 1300.

Update commands 1310 provide a number of commands relating to the displayed analytics. The update commands 1310 allow selection of the presentations for which the analytics in UI 1300 apply. The update commands 1310 also allows selection of the date range covered by the analytics and refreshing when the data was last updated. The update commands 1310 also show the current selections for these commands. The update commands 1310 also allow to export the analytics to a spreadsheet program or to email a class or group of students.

UI 1300 illustrates analytics about the consumption of lessons broken down by user, as evidenced by selection toggle 1312. The selection toggle 1312 allows the analytics for an augmented presentation document 106 to be viewed by slides or by users. User summary statistics 1314 details a number of aggregate statistics for the users of the augmented presentation document 106. Below the user summary statistics 1314 are a number of fields that contain analytics for individual users. These fields include name field 1316, slide progress field 1318, time spent field 1320, number of quizzes field 1322 and percentage correct field 1324.

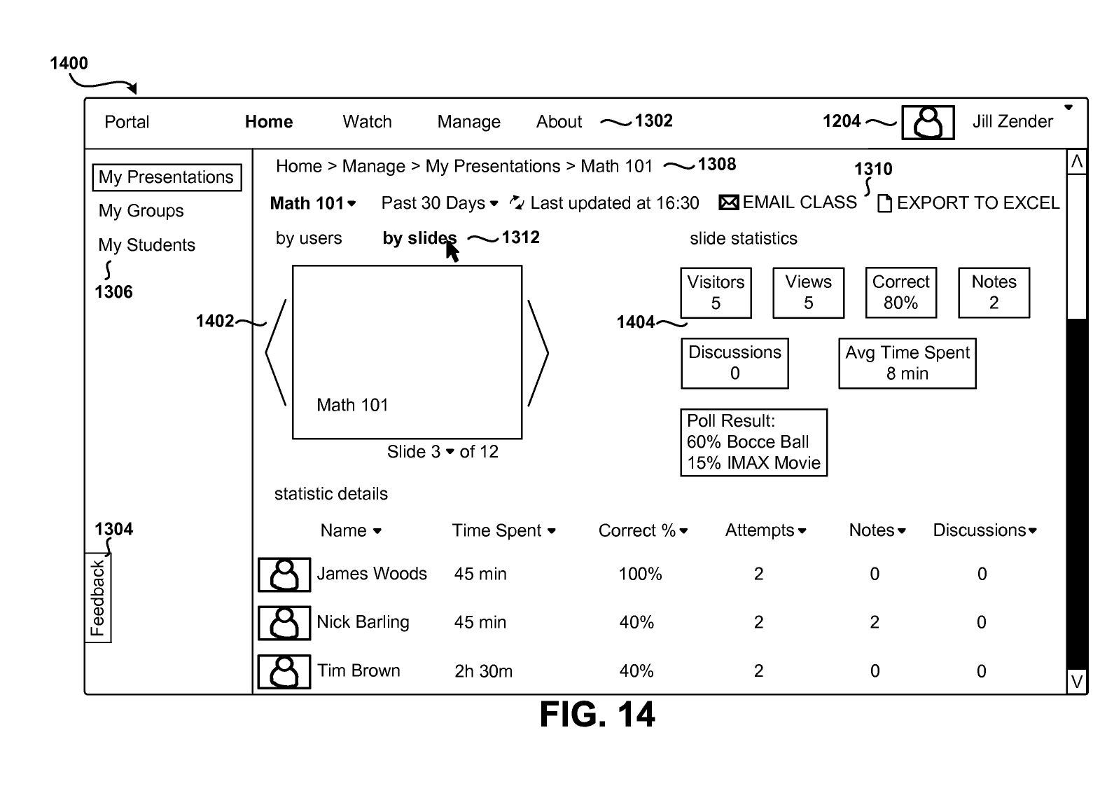

The UI 1400 shown in FIG. 14 shows analytics of the consumption of lessons broken down by slide. The change from UI 1300 to UI 1400 may occur by selecting “by slides” option with the selection toggle 1312. Alternatively, the view may return to UI diagram 1300 by selecting “by users” option with the selection toggle 1312. Slide selector 1402 shows the current slide for which the analytics in UI diagram 1400 applies. The slide selector 1402 allows a user to change the slide, which would change the displayed analytics. Slide summary statistics 1404 details a number of aggregate statistics for the users relating to the particular slide selected with slide selector 1402. Below the user summary statistics 1404 are a number of fields that contain analytics for individual users relating to the single slide selected.

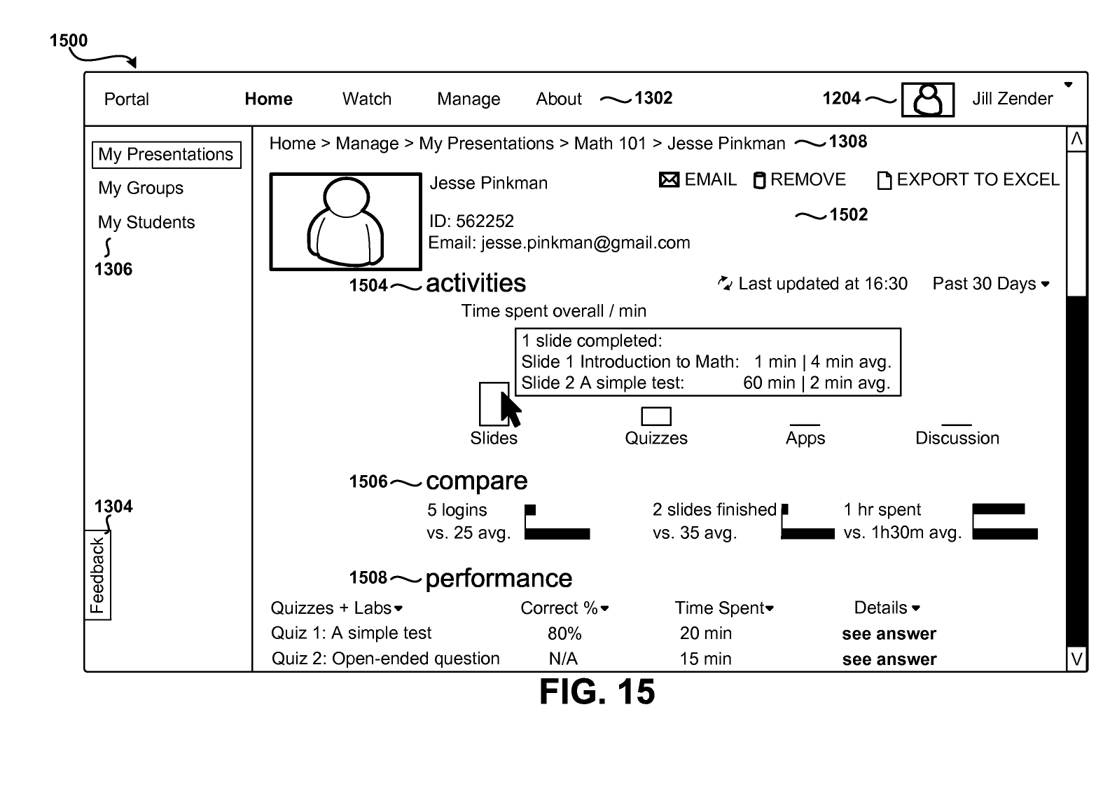

FIG. 15 illustrates a UI 1500 which shows analytics for an individual user's consumption of lessons. In this example, the navigation menu 1308 has been updated to reflect that the analytics in UI 1500 relate to a single user. The UI 1500 has user ID section 1502, activities section 1504, compare section 1506 and performance section 1508.

The user ID section 1502 details a user name, user ID number, user email along with the profile picture of the user. The user ID section 1502 also for directly contacting the user via email or exporting the display user information to a spreadsheet program. Additionally, the user represented in the UI 1500 may be removed by using a command in the user ID section 1502.

The activities section 1504 lists a number of activities of the selected user by presenting a number of charts. Hovering over one of these charts with the cursor 1214 reveals more information in the form of a pop-up window. The compare section 1506 lists a number of analytics for the selected user in comparison to the aggregate average of a group of users. The performance section 1508 presents analytics for the selected user relating to performance on individual quiz objects 116 and interactive lab objects 122. It should be appreciated that the UIs presented herein are merely illustrative and that other configurations of UIs might be utilized in other implementations.

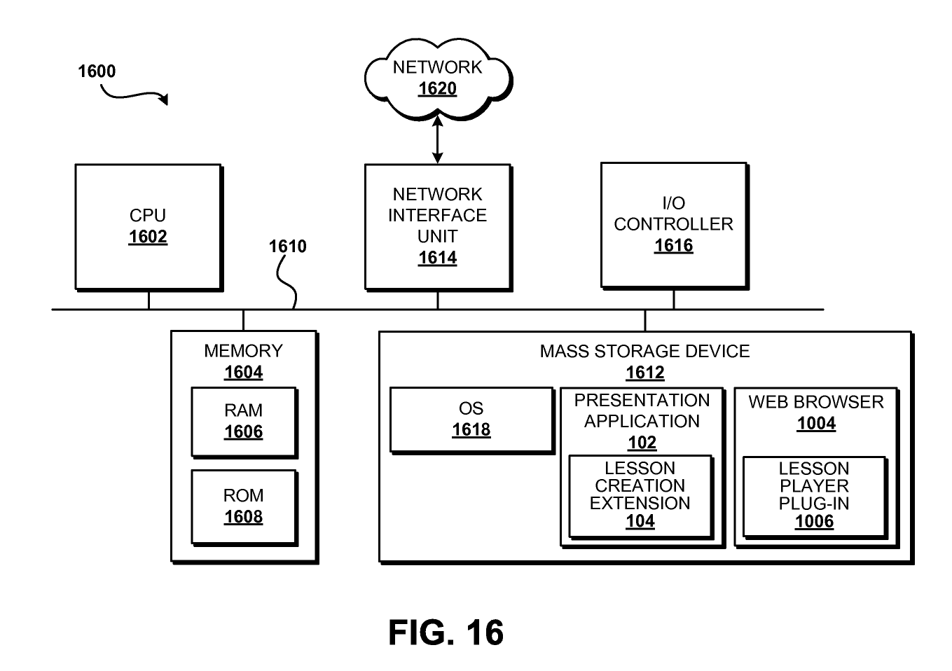

FIG. 16 illustrates a computer architecture 1600 for a device capable of executing some or all of the software components described herein for authoring, sharing, and consuming online courses. Thus, the computer architecture 1600 illustrated in FIG. 16 illustrates an architecture for a server computer, mobile phone, a PDA, a smart phone, a desktop computer, a netbook computer, a tablet computer, and/or a laptop computer. The computer architecture 1600 may be utilized to execute any aspects of the software components presented herein.

The computer architecture 1600 illustrated in FIG. 16 includes a central processing unit 1602 (“CPU”), a system memory 1604, including a random access memory 1606 (“RAM”) and a read-only memory (“ROM”) 1608, and a system bus 1610 that couples the memory 1604 to the CPU 1602. A basic input/output system containing the basic routines that help to transfer information between elements within the computer architecture 1600, such as during startup, is stored in the ROM 1608. The computer architecture 1600 further includes a mass storage device 1612 for storing the operating system 1618 and one or more application programs including, but not limited to, a presentation application 102, a lesson creation extension 104, a web browser program 1004, and a lesson player browser plug-in 1006. Other executable software components and data might also be stored in the mass storage device 1612.

The mass storage device 1612 is connected to the CPU 1602 through a mass storage controller (not shown) connected to the bus 1610. The mass storage device 1612 and its associated computer-readable media provide non-volatile storage for the computer architecture 1600. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 1600. For purposes of the claims, the phrase “computer storage medium,” and variations thereof, does not include waves or signals per se and/or communication media.

According to various configurations, the computer architecture 1600 may operate in a networked environment using logical connections to remote computers through a network such as the network 1620. The computer architecture 1600 may connect to the network 1620 through a network interface unit 1614 connected to the bus 1610. It should be appreciated that the network interface unit 1614 also may be utilized to connect to other types of networks and remote computer systems. The computer architecture 1600 also may include an input/output controller 1616 for receiving and processing input from a number of other devices, including a keyboard, mouse, or electronic stylus (not shown in FIG. 16). Similarly, the input/output controller 1616 may provide output to a display screen, a printer, or other type of output device (also not shown in FIG. 16).

It should be appreciated that the software components described herein may, when loaded into the CPU 1602 and executed, transform the CPU 1602 and the overall computer architecture 1600 from a general-purpose computing system into a special-purpose computing system customized to facilitate the functionality presented herein. The CPU 1602 may be constructed from any number of transistors or other discrete circuit elements, which may individually or collectively assume any number of states. More specifically, the CPU 1602 may operate as a finite-state machine, in response to executable instructions contained within the software modules disclosed herein. These computer-executable instructions may transform the CPU 1602 by specifying how the CPU 1602 transitions between states, thereby transforming the transistors or other discrete hardware elements constituting the CPU 1602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1600 in order to store and execute the software components presented herein. It also should be appreciated that the computer architecture 1600 may include other types of computing devices, including hand-held computers, embedded computer systems, personal digital assistants, and other types of computing devices known to those skilled in the art. It is also contemplated that the computer architecture 1600 may not include all of the components shown in FIG. 16, may include other components that are not explicitly shown in FIG. 16, or may utilize an architecture completely different than that shown in FIG. 16.

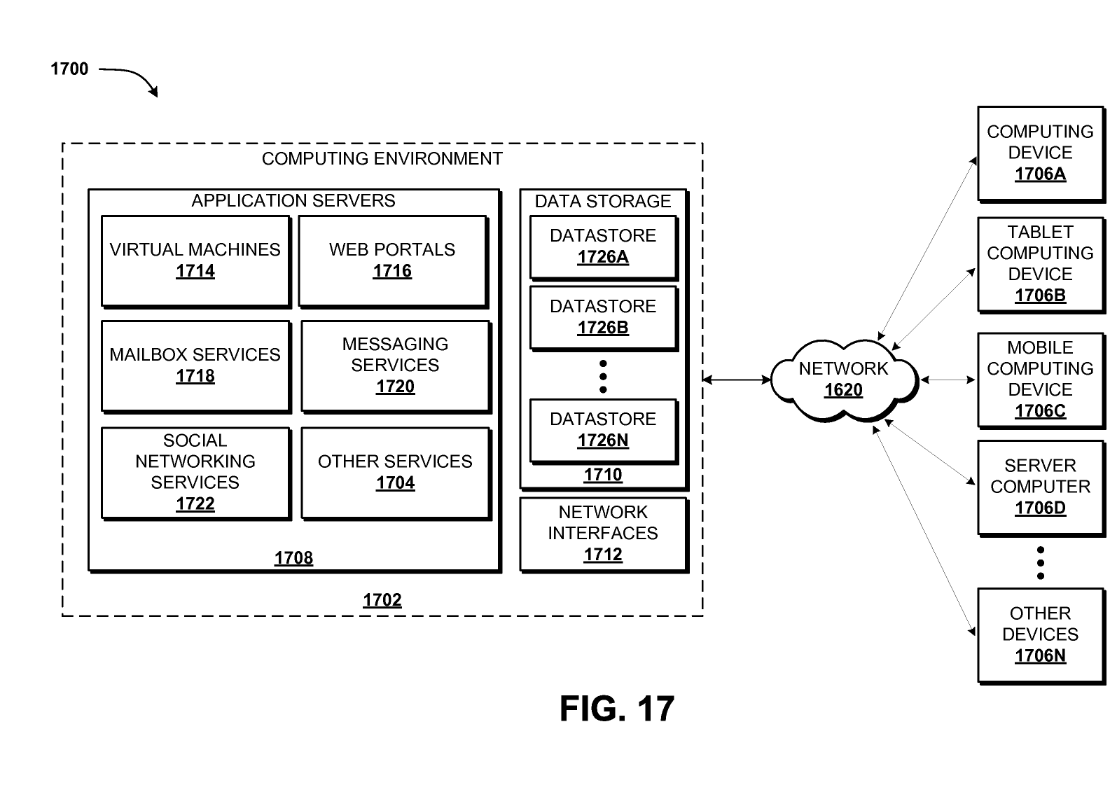

Turning now to FIG. 17, which illustrates an illustrative distributed computing environment 1700 capable of executing the software components described herein for authoring, sharing, and consuming online courses. Thus, the distributed computing environment 1700 illustrated in FIG. 17 can be used to provide the functionality described herein with respect to the FIGS. 1-15. Computing devices in the distributed computing environment 1700 thus may be utilized to execute any aspects of the software components presented herein.

According to various implementations, the distributed computing environment 1700 includes a computing environment 1702 operating on, in communication with, or as part of the network 1620. The network 1620 also can include various access networks. One or more client devices 1706A-1706N (hereinafter referred to collectively and/or generically as “clients 1706”) can communicate with the computing environment 1702 via the network 1620 and/or other connections (not illustrated in FIG. 17).

In the illustrated configuration, the clients 1706 include a computing device 1706A such as a laptop computer, a desktop computer, or other computing device; a slate or tablet computing device (“tablet computing device”) 1706B; a mobile computing device 1706C such as a mobile telephone, a smart phone, or other mobile computing device; a server computer 1706D; and/or other devices 1706N. It should be understood that any number of clients 1706 can communicate with the computing environment 1702. Two example computing architectures for the clients 1706 are illustrated and described herein with reference to FIGS. 16 and 18. It should be understood that the illustrated clients 1706 and computing architectures illustrated and described herein are illustrative, and should not be construed as being limited in any way.

In the illustrated configuration, the computing environment 1702 includes application servers 1708, data storage 1710, and one or more network interfaces 1712. According to various implementations, the functionality of the application servers 1708 can be provided by one or more server computers that are executing as part of, or in communication with, the network 1620. The application servers 1708 can host various services, virtual machines, portals, and/or other resources. In the illustrated configuration, the application servers 1708 host one or more virtual machines 1714 for hosting applications or other functionality. According to various implementations, the virtual machines 1714 host one or more applications and/or software modules for providing the functionality described herein for authoring, sharing, and consuming online courses. It should be understood that this configuration is illustrative, and should not be construed as being limiting in any way. The application servers 1708 also host or provide access to one or more web portals, link pages, web sites, and/or other information (“web portals”) 1716.

According to various implementations, the application servers 1708 also include one or more mailbox services 1718 and one or more messaging services 1720. The mailbox services 1718 can include electronic mail (“email”) services. The mailbox services 1718 also can include various personal information management (“PIM”) services including, but not limited to, calendar services, contact management services, collaboration services, and/or other services. The messaging services 1720 can include, but are not limited to, instant messaging services, chat services, forum services, and/or other communication services.

The application servers 1708 also can include one or more social networking services 1722. The social networking services 1722 can include various social networking services including, but not limited to, services for sharing or posting status updates, instant messages, links, photos, videos, and/or other information; services for commenting or displaying interest in articles, products, blogs, or other resources; and/or other services.

In some configurations, the social networking services 1722 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1722 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from MICROSOFT CORPORATION in Redmond, Wash. Other services are possible and are contemplated.

The social networking services 1722 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 1722 are not mentioned herein for the sake of brevity. As such, the above configurations are illustrative, and should not be construed as being limited in any way.

As shown in FIG. 17, the application servers 1708 also can host other services, applications, portals, and/or other resources (“other resources”) 1704. The other resources 1704 can include, but are not limited to, the functionality described above as being provided by the portal system 110. It thus can be appreciated that the computing environment 1702 can provide integration of the concepts and technologies disclosed herein provided herein for authoring, sharing, and consuming online courses with various mailbox, messaging, social networking, and/or other services or resources.

As mentioned above, the computing environment 1702 can include the data storage 1710. According to various implementations, the functionality of the data storage 1710 is provided by one or more databases operating on, or in communication with, the network 1620. The functionality of the data storage 1710 also can be provided by one or more server computers configured to host data for the computing environment 1702. The data storage 1710 can include, host, or provide one or more real or virtual datastores 1726A-1726N (hereinafter referred to collectively and/or generically as “datastores 1726”). The datastores 1726 are configured to host data used or created by the application servers 1708 and/or other data.

The computing environment 1702 can communicate with, or be accessed by, the network interfaces 1712. The network interfaces 1712 can include various types of network hardware and software for supporting communications between two or more computing devices including, but not limited to, the clients 1706 and the application servers 1708. It should be appreciated that the network interfaces 1712 also may be utilized to connect to other types of networks and/or computer systems.

It should be understood that the distributed computing environment 1700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1700 provides the software functionality described herein as a service to the clients 1706.

It should also be understood that the clients 1706 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1700 to utilize the functionality described herein for authoring, sharing, and consuming online courses

Turning now to FIG. 18, an illustrative computing device architecture 1800 will be described for a computing device that is capable of executing various software components described herein for authoring, sharing, and consuming online courses. The computing device architecture 1800 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. Moreover, the computing device architecture 1800 is applicable to any of the clients 1706 shown in FIG. 17. Furthermore, aspects of the computing device architecture 1800 may be applicable to traditional desktop computers, portable computers (e.g., laptops, notebooks, ultra-portables, and netbooks), server computers, and other computer systems. For example, the single touch and multi-touch aspects disclosed herein below may be applied to desktop computers that utilize a touchscreen or some other touch-enabled device, such as a touch-enabled track pad or touch-enabled mouse.

The computing device architecture 1800 illustrated in FIG. 18 includes a processor 1802, memory components 1804, network connectivity components 1806, sensor components 1808, input/output components 1810, and power components 1812. In the illustrated configuration, the processor 1802 is in communication with the memory components 1804, the network connectivity components 1806, the sensor components 1808, the input/output (“I/O”) components 1810, and the power components 1812. Although no connections are shown between the individuals components illustrated in FIG. 18, the components can interact to carry out device functions. In some configurations, the components are arranged so as to communicate via one or more busses (not shown).

The processor 1802 includes a central processing unit (“CPU”) configured to process data, execute computer-executable instructions of one or more application programs, and communicate with other components of the computing device architecture 1800 in order to perform various functionality described herein. The processor 1802 may be utilized to execute aspects of the software components presented herein and, particularly, those that utilize, at least in part, a touch-enabled input.

In some configurations, the processor 1802 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some configurations, the processor 1802 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 1802 is, or is included in, a system-on-chip (“SoC”) along with one or more of the other components described herein below. For example, the SoC may include the processor 1802, a GPU, one or more of the network connectivity components 1806, and one or more of the sensor components 1808. In some configurations, the processor 1802 is fabricated, in part, utilizing a package-on-package (“PoP”) integrated circuit packaging technique. Moreover, the processor 1802 may be a single core or multi-core processor.

The processor 1802 may be created in accordance with an ARM architecture, available for license from ARM HOLDINGS of Cambridge, United Kingdom. Alternatively, the processor 1802 may be created in accordance with an x86 architecture, such as is available from INTEL CORPORATION of Mountain View, Calif. and others. In some configurations, the processor 1802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1804 include a random access memory (“RAM”) 1814, a read-only memory (“ROM”) 1816, an integrated storage memory (“integrated storage”) 1818, and a removable storage memory (“removable storage”) 1820. In some configurations, the RAM 1814 or a portion thereof, the ROM 1816 or a portion thereof, and/or some combination the RAM 1814 and the ROM 1816 is integrated in the processor 1802. In some configurations, the ROM 1816 is configured to store a firmware, an operating system 1618 or a portion thereof (e.g., operating system kernel), and/or a bootloader to load an operating system 1618 kernel from the integrated storage 1818 or the removable storage 1820.

The integrated storage 1818 can include a solid-state memory, a hard disk, or a combination of solid-state memory and a hard disk. The integrated storage 1818 may be soldered or otherwise connected to a logic board upon which the processor 1802 and other components described herein also may be connected. As such, the integrated storage 1818 is integrated in the computing device. The integrated storage 1818 is configured to store an operating system 1618 or portions thereof, application programs, data, and other software components described herein.

The removable storage 1820 can include a solid-state memory, a hard disk, or a combination of solid-state memory and a hard disk. In some configurations, the removable storage 1820 is provided in lieu of the integrated storage 1818. In other configurations, the removable storage 1820 is provided as additional optional storage. In some configurations, the removable storage 1820 is logically combined with the integrated storage 1818 such that the total available storage is made available and shown to a user as a total combined capacity of the integrated storage 1818 and the removable storage 1820.

The removable storage 1820 is configured to be inserted into a removable storage memory slot (not shown) or other mechanism by which the removable storage 1820 is inserted and secured to facilitate a connection over which the removable storage 1820 can communicate with other components of the computing device, such as the processor 1802. The removable storage 1820 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1804 can store an operating system 1618. According to various configurations, the operating system 1618 includes, but is not limited to, WINDOWS MOBILE OS from MICROSOFT CORPORATION of Redmond, Wash., WINDOWS PHONE OS from MICROSOFT CORPORATION, WINDOWS from Microsoft Corporation, BLACKBERRY OS from RESEARCH IN MOTION LIMITED of Waterloo, Ontario, Canada, IOS from APPLE INC. of Cupertino, Calif., and ANDROID OS from GOOGLE INC. of Mountain View, Calif. Other operating systems are contemplated.

The network connectivity components 1806 include a wireless wide area network component (“WWAN component”) 1822, a wireless local area network component (“WLAN component”) 1824, and a wireless personal area network component (“WPAN component”) 1826. The network connectivity components 1806 facilitate communications to and from a network 1620, which may be a WWAN, a WLAN, or a WPAN. Although a single network 1620 is illustrated, the network connectivity components 1806 may facilitate simultaneous communication with multiple networks. For example, the network connectivity components 1806 may facilitate simultaneous communications with multiple networks via one or more of a WWAN, a WLAN, or a WPAN.

The network 1620 may be a WWAN, such as a mobile telecommunications network utilizing one or more mobile telecommunications technologies to provide voice and/or data services to a computing device utilizing the computing device architecture 1800 via the WWAN component 1822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 1620 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE (“Long-Term Evolution”), and various other current and future wireless data access standards. The network 1620 may be configured to provide voice and/or data communications with any combination of the above technologies. The network 1620 may be configured to or adapted to provide voice and/or data communications in accordance with future generation technologies.

In some configurations, the WWAN component 1822 is configured to provide dual-multi-mode connectivity to the network 1620. For example, the WWAN component 1822 may be configured to provide connectivity to the network 1620, wherein the network 1620 provides service via GSM and UMTS technologies, or via some other combination of technologies. Alternatively, multiple WWAN components 1822 may be utilized to perform such functionality, and/or provide additional functionality to support other non-compatible technologies (i.e., incapable of being supported by a single WWAN component). The WWAN component 1822 may facilitate similar connectivity to multiple networks (e.g., a UMTS network and an LTE network).

The network 1620 may be a WLAN operating in accordance with one or more Institute of Electrical and Electronic Engineers (“IEEE”) 802.11 standards, such as IEEE 802.11a, 802.11b, 802.11g, 802.11n, 802.11ac and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1824 is configured to connect to the network 1620 via the WI-FI access points. Such connections may be secured via various encryption technologies including, but not limited, WI-FI Protected Access (“WPA”), WPA2, Wired Equivalent Privacy (“WEP”), and the like.

The network 1620 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1826 is configured to facilitate communications with other devices, such as peripherals, computers, or other computing devices via the WPAN.

The sensor components 1808 include a magnetometer 1830, an ambient light sensor 1832, a proximity sensor 1834, an accelerometer 1836, a gyroscope 1838, and a Global Positioning System sensor (“GPS sensor”) 1840. It is contemplated that other sensors, such as, but not limited to, temperature sensors or shock detection sensors, also may be incorporated in the computing device architecture 1800.

The magnetometer 1830 is configured to measure the strength and direction of a magnetic field. In some configurations the magnetometer 1830 provides measurements to a compass application program stored within one of the memory components 1804 in order to provide a user with accurate directions in a frame of reference including the cardinal directions, north, south, east, and west. Similar measurements may be provided to a navigation application program that includes a compass component. Other uses of measurements obtained by the magnetometer 1830 are contemplated.

The ambient light sensor 1832 is configured to measure ambient light. In some configurations, the ambient light sensor 1832 provides measurements to an application program stored within one the memory components 1804 in order to automatically adjust the brightness of a display (described below) to compensate for low-light and high-light environments. Other uses of measurements obtained by the ambient light sensor 1832 are contemplated.

The proximity sensor 1834 is configured to detect the presence of an object or thing in proximity to the computing device without direct contact. In some configurations, the proximity sensor 1834 detects the presence of a user's body (e.g., the user's face) and provides this information to an application program stored within one of the memory components 1804 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1834 are contemplated.

The accelerometer 1836 is configured to measure proper acceleration. In some configurations, output from the accelerometer 1836 is used by an application program as an input mechanism to control some functionality of the application program. For example, the application program may be a video game in which a character, a portion thereof, or an object is moved or otherwise manipulated in response to input received via the accelerometer 1836. In some configurations, output from the accelerometer 1836 is provided to an application program for use in switching between landscape and portrait modes, calculating coordinate acceleration, or detecting a fall. Other uses of the accelerometer 1836 are contemplated.

The gyroscope 1838 is configured to measure and maintain orientation. In some configurations, output from the gyroscope 1838 is used by an application program as an input mechanism to control some functionality of the application program. For example, the gyroscope 1838 can be used for accurate recognition of movement within a 3D environment of a video game application or some other application. In some configurations, an application program utilizes output from the gyroscope 1838 and the accelerometer 1836 to enhance control of some functionality of the application program. Other uses of the gyroscope 1838 are contemplated.

The GPS sensor 1840 is configured to receive signals from GPS satellites for use in calculating a location. The location calculated by the GPS sensor 1840 may be used by any application program that requires or benefits from location information. For example, the location calculated by the GPS sensor 1840 may be used with a navigation application program to provide directions from the location to a destination or directions from the destination to the location. Moreover, the GPS sensor 1840 may be used to provide location information to an external location-based service, such as E911 service. The GPS sensor 1840 may obtain location information generated via WI-FI, WIMAX, and/or cellular triangulation techniques utilizing one or more of the network connectivity components 1806 to aid the GPS sensor 1840 in obtaining a location fix. The GPS sensor 1840 may also be used in Assisted GPS (“A-GPS”) systems.

The I/O components 1810 include a display 1842, a touchscreen 1844, a data I/O interface component (“data I/O”) 1846, an audio I/O interface component (“audio I/O”) 1848, a video I/O interface component (“video I/O”) 1850, and a camera 1852. In some configurations, the display 1842 and the touchscreen 1844 are combined. In some configurations two or more of the data I/O component 1846, the audio I/O component 1848, and the video I/O component 1850 are combined. The I/O components 1810 may include discrete processors configured to support the various interface described below, or may include processing functionality built-in to the processor 1802.

The display 1842 is an output device configured to present information in a visual form. In particular, the display 1842 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1842 is a liquid crystal display (“LCD”) utilizing any active or passive matrix technology and any backlighting technology (if used). In some configurations, the display 1842 is an organic light emitting diode (“OLED”) display. Other display types are contemplated.

The touchscreen 1844 is an input device configured to detect the presence and location of a touch. The touchscreen 1844 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 1844 is incorporated on top of the display 1842 as a transparent layer to enable a user to use one or more touches to interact with objects or other information presented on the display 1842. In other configurations, the touchscreen 1844 is a touch pad incorporated on a surface of the computing device that does not include the display 1842. For example, the computing device may have a touchscreen incorporated on top of the display 1842 and a touch pad on a surface opposite the display 1842.

In some configurations, the touchscreen 1844 is a single-touch touchscreen. In other configurations, the touchscreen 1844 is a multi-touch touchscreen. In some configurations, the touchscreen 1844 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1844. As such, a developer may create gestures that are specific to a particular application program.

In some configurations, the touchscreen 1844 supports a tap gesture in which a user taps the touchscreen 1844 once on an item presented on the display 1842. The tap gesture may be used for various reasons including, but not limited to, opening or launching whatever the user taps. In some configurations, the touchscreen 1844 supports a double tap gesture in which a user taps the touchscreen 1844 twice on an item presented on the display 1842. The double tap gesture may be used for various reasons including, but not limited to, zooming in or zooming out in stages. In some configurations, the touchscreen 1844 supports a tap and hold gesture in which a user taps the touchscreen 1844 and maintains contact for at least a pre-defined time. The tap and hold gesture may be used for various reasons including, but not limited to, opening a context-specific menu.

In some configurations, the touchscreen 1844 supports a pan gesture in which a user places a finger on the touchscreen 1844 and maintains contact with the touchscreen 1844 while moving the finger on the touchscreen 1844. The pan gesture may be used for various reasons including, but not limited to, moving through screens, images, or menus at a controlled rate. Multiple finger pan gestures are also contemplated. In some configurations, the touchscreen 1844 supports a flick gesture in which a user swipes a finger in the direction the user wants the screen to move. The flick gesture may be used for various reasons including, but not limited to, scrolling horizontally or vertically through menus or pages. In some configurations, the touchscreen 1844 supports a pinch and stretch gesture in which a user makes a pinching motion with two fingers (e.g., thumb and forefinger) on the touchscreen 1844 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1844. As such, the above gestures should be understood as being illustrative and should not be construed as being limiting in any way.

The data I/O interface component 1846 is configured to facilitate input of data to the computing device and output of data from the computing device. In some configurations, the data I/O interface component 1846 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 1848 is configured to provide audio input and/or output capabilities to the computing device. In some configurations, the audio I/O interface component 1848 includes a microphone configured to collect audio signals. In some configurations, the audio I/O interface component 1848 includes a headphone jack configured to provide connectivity for headphones or other external speakers. In some configurations, the audio interface component 1848 includes a speaker for the output of audio signals. In some configurations, the audio I/O interface component 1848 includes an optical audio cable out.

The video I/O interface component 1850 is configured to provide video input and/or output capabilities to the computing device. In some configurations, the video I/O interface component 1850 includes a video connector configured to receive video as input from another device (e.g., a video media player such as a DVD or BLURAY player) or send video as output to another device (e.g., a monitor, a television, or some other external display). In some configurations, the video I/O interface component 1850 includes a High-Definition Multimedia Interface (“HDMI”), mini-HDMI, micro-HDMI, DisplayPort, or proprietary connector to input/output video content. In some configurations, the video I/O interface component 1850 or portions thereof is combined with the audio I/O interface component 1848 or portions thereof.

The camera 1852 can be configured to capture still images and/or video. The camera 1852 may utilize a charge coupled device (“CCD”) or a complementary metal oxide semiconductor (“CMOS”) image sensor to capture images. In some configurations, the camera 1852 includes a flash to aid in taking pictures in low-light environments. Settings for the camera 1852 may be implemented as hardware or software buttons.

Although not illustrated, one or more hardware buttons may also be included in the computing device architecture 1800. The hardware buttons may be used for controlling some operational aspect of the computing device. The hardware buttons may be dedicated buttons or multi-use buttons. The hardware buttons may be mechanical or sensor-based.

The illustrated power components 1812 include one or more batteries 1854, which can be connected to a battery gauge 1856. The batteries 1854 may be rechargeable or disposable. Rechargeable battery types include, but are not limited to, lithium polymer, lithium ion, nickel cadmium, and nickel metal hydride. Each of the batteries 1854 may be made of one or more cells.

The battery gauge 1856 can be configured to measure battery parameters such as current, voltage, and temperature. In some configurations, the battery gauge 1856 is configured to measure the effect of a battery's discharge rate, temperature, age and other factors to predict remaining life within a certain percentage of error. In some configurations, the battery gauge 1856 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1812 may also include a power connector, which may be combined with one or more of the aforementioned I/O components 1810. The power components 1812 may interface with an external power system or charging equipment via a power I/O component.

Based on the foregoing, it should be appreciated that technologies for authoring, sharing, and consuming online courses have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A system for publishing an augmented presentation document comprising:
a processor; and
a memory communicatively coupled to the processor and storing computer-executable instructions which, when executed by the processor, cause the processor to
receive the augmented presentation document, the augmented presentation document comprising one or more slides, the one or more slides having one or more associated objects,
extract the one or more objects from the augmented presentation document,
store the one or more objects by object type, whereby objects of the same object type are stored together,
receive a request to present the augmented presentation document,
in response to receiving the request, retrieve the stored one or more objects, and
cause the augmented presentation document to be presented such that the objects are presented in synchronization.

2. The system of claim 1, wherein the one or more objects comprise at least a video object or an audio object.

3. The system of claim 2, wherein causing the augmented presentation document to be presented comprises presenting the video object or the audio object in synchronization with the one or more slides.

4. The system of claim 3, wherein the one or more objects further comprises at least a digital ink object.

5. The system of claim 4, wherein causing the augmented presentation document to be presented comprises causing the digital ink object to be presented in synchronization with the video object or the audio object.

6. The system of claim 3, wherein the memory stores further instructions which, when executed by the processor, further cause the processor to:
receive a command to reorder the one or more slides; and
reorder the one or more slides of the augmented presentation document in response to receiving the command, whereby the video object or the audio object will be presented in synchronization with the reordered one or more slides during playback.

7. The system of claim 3, wherein the memory stores further instructions which, when executed by the processor, further cause the processor to set a default playback speed for which the augmented presentation document is presented, wherein the default playback speed is different than a speed at which the one or more objects were recorded.

8. A computer-implemented method for creating an augmented presentation document, the method comprising executing computer-implemented instructions for:
executing a lesson creation extension in a presentation application to create the augmented presentation document, the augmented presentation document comprising one or more slides;
recording one or more types of content; and
segmenting the one or more types of content into one or more objects, whereby each object is associated with a slide of the one or more slides such that the one or more objects and the one or more slides will be presented in synchronization during playback.

9. The computer-implemented method of claim 8, wherein the one or more objects comprise at least one of a video object or an audio object, whereby the video object and the audio object are synchronized with the associated slide, and whereby the associated slide is displayed when the one or more types of content are recorded.

10. The computer-implemented method of claim 9, wherein the one or more objects further comprise at least a digital ink object, and wherein playback of the digital ink object is synchronized with playback of the video object or the audio object.

11. The computer-implemented method of claim 9, further comprising reordering the one or more slides, whereby the association of the one or more objects with the one or more slides does not change and playback of the video object or the audio object is made in synchronization with the reordered one or more slides during playback.

12. The computer-implemented method of claim 8, further comprising setting a default playback speed at which the augmented presentation document is played back, and wherein the default playback speed is a speed that is different than a speed at which the one or more objects were recorded.

13. A computer-implemented method, comprising:
receiving an augmented presentation document comprising one or more slides, the one or more slides having one or more associated objects;
extracting the one or more objects from the augmented presentation document;
storing the one or more objects by object type, whereby objects of the same object type are stored together;
receiving a request to present the augmented presentation document;
in response to receiving the request, retrieving the stored one or more objects; and
causing the augmented presentation document to be presented such that the one or more objects are presented in synchronization.

14. The computer-implemented method of claim 13, further comprising:
updating at least one stored object;
receiving the request to present the augmented presentation document;
in response to receiving the request, retrieving the stored one or more objects comprising the at least one stored updated object; and
causing the augmented presentation document to be presented such that the one or more objects comprising the at least one stored updated object are presented in synchronization.

15. The computer-implemented method of claim 13, wherein the one or more objects comprise at least a video object or an audio object.

16. The computer-implemented method of claim 15, wherein causing the augmented presentation document to be presented comprises playing back the video object or the audio object in synchronization with the one or more slides.

17. The computer-implemented method of claim 16, wherein the one or more objects further comprise at least a digital ink object, and wherein causing the augmented presentation document to be presented comprises presenting playback of the digital ink object in synchronization with playback of the video object or the audio object.

18. The computer-implemented method of claim 13, further comprising causing the computer to share the augmented presentation document with one or more users via a hyperlink.

19. The computer-implemented method of claim 18, further comprising collecting information indicating a usage of the augmented presentation document.

20. The computer-implemented method of claim 19, wherein the collected information comprises data indicating the time spent on the one or more slides by the one or more users.
